(19) United States
(12) Patent Application Publication
(10) Pub. No.: US 2026/0029900 A1
(43) Pub. Date: Jan. 29, 2026

(54) CONTENT EXTRACTION METHOD AND APPARATUS, ELECTRONIC DEVICE, AND STORAGE MEDIUM

(71) Applicant: TENCENT TECHNOLOGY (SHENZHEN) COMPANY LIMITED, Shenzhen (CN)

(72) Inventors: Yajing HE, Shenzhen (CN); Jiahao LI, Shenzhen (CN); Lifu WANG, Shenzhen (CN); Yue ZHANG, Shenzhen (CN); Qingxiang LIN, Shenzhen (CN); Huiwen SHI, Shenzhen (CN); Wei ZHANG, Shenzhen (CN); Chunchao GUO, Shenzhen (CN); Jie XIAO, Shenzhen (CN); Canshuang ZHENG, Shenzhen (CN)

(73) Assignee: TENCENT TECHNOLOGY (SHENZHEN) COMPANY LIMITED, Shenzhen (CN)

(21) Appl. No.: 19/346,870

(22) Filed: Oct. 1, 2025

Related U.S. Application Data
(63) Continuation of application No. PCT/CN2024/121280, filed on Sep. 26, 2024.

(30) Foreign Application Priority Data
Sep. 27, 2023 (CN) 202311282882.0

(51) Int. Cl. G06F 3/0484; G06F 3/0482

(52) U.S. Cl. CPC G06F 3/0484; G06F 3/0482

(57) ABSTRACT

A content extraction method and apparatus including presenting a document selection interface based on an uploading operation in an information exchange interface, the document selection interface comprising at least one document, based on a selection operation on a first document of the at least one document, presenting, in the information exchange interface, the first document and processing information of the first document in a status area corresponding to the first document, the processing information indicating a current processing stage in a process of performing content extraction on the first document and a corresponding processing status, and after the content extraction on the first document is completed, removing display of the status area, and presenting, in the information exchange interface, a document digest obtained by performing content extraction on the first document.

### CROSS-REFERENCE TO RELATED APPLICATIONS

This application is a continuation application of International Application No. PCT/CN2024/121280 filed on Sep. 26, 2024, which claims priority to Chinese Patent Application No. 202311282882.0, filed with the China National Intellectual Property Administration on Sep. 27, 2023, the disclosures of each being incorporated by reference herein in their entireties.

### FIELD

The disclosure relates to the field of computer technologies, in particular, to the field of artificial intelligence technologies, and provides a content extraction method and apparatus, an electronic device, and a storage medium.

### BACKGROUND

With the popularization of computer technologies and the rapid rise of the Internet, it is more convenient for people to obtain and transmit information. Network resources on the Internet increase at an unprecedented speed, and a large amount of information appears to people in a form of documents.

Specifically, the network resources on the Internet, such as various documents such as news reports, scientific papers, legal files, novels, financial reports, and teaching materials, are all huge sources of text data. Additionally, the emergence of some self-media platforms has further complicated presentation formats of text information. Although high-speed informatization development brings convenience to people, information explosion also brings challenges, and it is difficult for users to learn of key content from massive information in time. Therefore, it is particularly urgent and important to extract main content of various documents.

### SUMMARY

Some embodiments provides a content extraction method. The method includes: presenting a document selection interface based on an uploading operation in an information exchange interface, the document selection interface comprising at least one document; based on a selection operation on a first document of the at least one document, presenting, in the information exchange interface, the first document and processing information of the first document in a status area corresponding to the first document, the processing information indicating a current processing stage in a process of performing content extraction on the first document and a corresponding processing status; and after the content extraction on the first document is completed, removing display of the status area, and presenting, in the information exchange interface, a document digest obtained by performing content extraction on the first document.

Some embodiments provides a content extraction apparatus. The apparatus includes: at least one memory configured to store computer program code; and at least one processor configured to read the program code and operate as instructed by the program code, the program code comprising: first response code configured to cause at least one of the at least one processor to present a document selection interface based on an uploading operation in an information exchange interface, the document selection interface comprising at least one document; and second response code configured to cause at least one the at least one processor to: based on a selection operation on a first document of the at least one document, present, in the information exchange interface, the first document and processing information of the first document in a status area corresponding to the first document, the processing information indicating a current processing stage in a process of performing content extraction on the first document and a corresponding processing status; and after the content extraction on the first document is completed, remove display of the status area, and present, in the information exchange interface, a document digest obtained by performing content extraction on the first document.

Some embodiments provides a non-transitory computer-readable storage medium, storing computer code which, when executed by at least one processor, causes the at least one processor to at least: present a document selection interface based on an uploading operation in an information exchange interface, the document selection interface comprising at least one document; based on a selection operation on a first document of the at least one document, present, in the information exchange interface, the first document and processing information of the first document in a status area corresponding to the first document, the processing information indicating a current processing stage in a process of performing content extraction on the first document and a corresponding processing status; and after the content extraction on the first document is completed, remove display of the status area, and present, in the information exchange interface, a document digest obtained by performing content extraction on the first document.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an application scenario according to some embodiments.

FIG. 2 is an implementation flowchart of a content extraction method according to some embodiments.

FIG. 3A is a schematic diagram of a function discovery interface and a document summary interface according to some embodiments.

FIG. 3B is a schematic diagram of another function discovery interface and another document summary interface according to some embodiments.

FIG. 4 is a schematic diagram of a process of viewing a document digest of an example document according to some embodiments.

FIG. 5 is a schematic diagram of a document summary interface and a document selection interface according to some embodiments.

FIG. 6 is a schematic diagram of a document selection interface according to some embodiments.

FIG. 7A is a schematic diagram of a status area according to some embodiments.

FIG. 7B is a schematic diagram of another status area according to some embodiments.

FIG. 8A is a schematic diagram of a default message and a status area according to some embodiments.

FIG. 8B is a schematic diagram of another default message and another status area according to some embodiments.

FIG. 9A is a schematic diagram of a status area in an expanded form according to some embodiments.

FIG. 9B is a schematic diagram of another status area in an expanded form according to some embodiments.

FIG. 10A is a schematic diagram of countdown information according to some embodiments.

FIG. 10B is a schematic diagram of other countdown information according to some embodiments.

FIG. 11 is a schematic diagram of still other countdown information according to some embodiments.

FIG. 12A is a schematic diagram of upload failure prompt information according to some embodiments.

FIG. 12B is a schematic diagram of other upload failure prompt information according to some embodiments.

FIG. 13A is a schematic diagram of a processing stage anomaly according to some embodiments.

FIG. 13B is a schematic diagram of another processing stage anomaly according to some embodiments.

FIG. 14 is a schematic diagram of a processing result according to some embodiments.

FIG. 15 is a schematic diagram of another processing result according to some embodiments.

FIG. 16 is a schematic diagram of a first document digest according to some embodiments.

FIG. 17A is a schematic diagram of a second document digest according to some embodiments.

FIG. 17B is a schematic diagram of a third document digest according to some embodiments.

FIG. 17C is a schematic diagram of a fourth document digest according to some embodiments.

FIG. 18A is a schematic diagram of a digest switching control according to some embodiments.

FIG. 18B is a schematic diagram of another digest switching control according to some embodiments.

FIG. 19A is a schematic diagram of a question-answer scenario for a document digest according to some embodiments.

FIG. 19B is a schematic diagram of another question-answer scenario for a document digest according to some embodiments.

FIG. 20 is a schematic diagram of a modification scenario for a document digest according to some embodiments.

FIG. 21 is a schematic diagram of a presentation style of a question and an answer message according to some embodiments.

FIG. 22 is a schematic diagram of a presentation manner of multiple first documents and document digests according to some embodiments.

FIG. 23 is a schematic diagram of another presentation manner of multiple first documents and document digests according to some embodiments.

FIG. 24 is a schematic diagram of still another presentation manner of multiple first documents and document digests according to some embodiments.

FIG. 25A is a schematic diagram of stop prompt information according to some embodiments.

FIG. 25B is a schematic diagram of other stop prompt information according to some embodiments.

FIG. 26A is a schematic diagram of exit prompt information according to some embodiments.

FIG. 26B is a schematic diagram of other exit prompt information according to some embodiments.

FIG. 27 is a schematic diagram of a second function control according to some embodiments.

FIG. 28A is a schematic diagram of a landing page for a recipient according to some embodiments.

FIG. 28B is a schematic diagram of another landing page for a recipient according to some embodiments.

FIG. 29 is a schematic diagram of a historical record according to some embodiments.

FIG. 30 is an implementation flowchart of another content extraction method according to some embodiments.

FIG. 31 is a schematic diagram of a process of extracting a rough digest of a single document according to some embodiments.

FIG. 32 is a schematic diagram of a process of extracting a summarized digest of multiple documents according to some embodiments.

FIG. 33 is a schematic diagram of a feature matching process according to some embodiments.

FIG. 34 is a schematic diagram of a document content parsing and question-answer scheduling procedure according to some embodiments.

FIG. 35 is a schematic structural diagram of a composition of a content extraction apparatus according to some embodiments.

FIG. 36 is a schematic structural diagram of a composition of a content extraction apparatus according to some embodiments.

FIG. 37 is a schematic structural diagram of a composition of hardware of an electronic device according to some embodiments.

FIG. 38 is a schematic structural diagram of a composition of hardware of an electronic device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Document digest and slice digest: The document digest is a digest obtained by summarizing overall content of a document, and the slice digest is a digest obtained by separately summarizing each text slice included in a document. Herein, summarizing refers to extracting content in a summarization manner. For example, summarization is digest extraction. The document digest is a summary of the overall content of the document, and one document may be divided into at least one text slice. One slice digest is a summary of content included in a corresponding text slice.

Text slice and content slice: The text slice is mainly applied in a digest extraction process, and is obtained by slicing text information included in a parsed document; while the content slice is mainly applied in a multi-round question-answer scenario, and is obtained by performing finer-grained division on a document according to a preset slice granularity (such as a paragraph granularity, a sentence granularity, or the like), which is used for subsequent feature matching with a question.

Processing stage (which may also be referred to as a processing node): The processing stage is determined after a process of performing content extraction on a document is divided into multiple operations. Each operation may be understood as one processing stage. Each operation corresponds to a processing status in the processing procedure of performing content extraction on the document, indicating that the operation is being processed, completed, not processed yet, processing failed, or the like.

Some embodiments provide a content extraction method and apparatus, an electronic device, and a storage medium, to help select a document and generate a digest of the document, so as to conveniently provide summarized content of the document, and further improve information presentation efficiency and reading efficiency.

In some embodiments, content extraction may be performed on the first document based on a natural language processing technology and a machine learning technology, to generate a document digest corresponding to the first document. This process may be realized based on an artificial intelligence-generated content (AIGC) technology. The process may be applied in multiple scenarios, such as extracting digests from text documents (which may include pictures and text), audio documents, video documents, and the like. In addition, based on this, multiple rounds of question-answer may be further performed with reference to the document digest. When multiple rounds of question-answer are inputted, a system performs similarity matching on a question of an object and a text feature of a document parsing result to find content in the document that is most related to the question of the object; and then performs summarization by using a model to output an answer.

In some embodiments, when the document digest, answers of the multiple rounds of question-answer, or the like are generated based on AIGC, a large language model (LLM) may be used. The LLM is a type of artificial intelligence model designed to understand and generate a human language. The LLM is trained on a large amount of text data and may perform a wide range of tasks, including text summarization, translation, sentiment analysis, and the like. The LLM is characterized by a large scale, including billions of parameters, which helps the LLM learn complex patterns in language data. These models are usually based on a deep learning architecture, such as a transformer, which helps the LLM achieve impressive performance in various NLP tasks.

A design solution according to some embodiments is briefly described below.

With the popularization of computer technologies and the rapid rise of the Internet, it is more convenient for people to obtain and transmit information. Network resources on the Internet increase at an unprecedented speed, and a large amount of information appears to people in a form of documents.

In some embodiments, the network resources on the Internet, such as various documents such as news reports, scientific papers, legal files, novels, financial reports, and teaching materials, are all huge sources of text data. Additionally, the emergence of some self-media platforms has further complicated presentation formats of text information. Although high-speed informatization development brings convenience to people, information explosion also brings challenges, and it is difficult for objects to learn of key content from massive information in time. Therefore, it is particularly urgent and important to extract main content of various documents.

In conclusion, how to perform content extraction on a document and provide convenient summary content of the document for a user to improve reading efficiency of document is urgently resolved.

In view of this, some embodiments provide a content extraction method and apparatus, an electronic device, and a storage medium. In some embodiments, an object, such as a user, may upload, according to a requirement of the object by using an information exchange interface, a first document on which content extraction needs to be performed, and then content extraction is automatically performed on the first document. After processing of performing content extraction on the first document is completed, a document digest obtained by performing content extraction on the first document may be directly presented to the object in the information exchange interface. The object may directly read information about the document digest, to quickly understand content of the first document, and further improve information presentation efficiency and reading efficiency. In addition, a process of performing content extraction on the first document may involve multiple processing stages, and execution of these processing stages may consume a period of time. To reduce a feeling of waiting of the object, manage expectation of the object, and avoid a loss of the object in a digest generation process, in some embodiments, a status area for presenting related progresses of the processing stages is set in the information exchange interface. In some embodiments, in the process of performing content extraction on the first document, a current processing stage and a corresponding processing status that correspond to the first document are directly presented to the object in the status area, to enhance experience of the object.

The following describes various embodiments with reference to the accompanying drawings. The embodiments described herein are not intended to be limiting. In addition, the embodiments and features in the embodiments may be mutually combined without conflict.

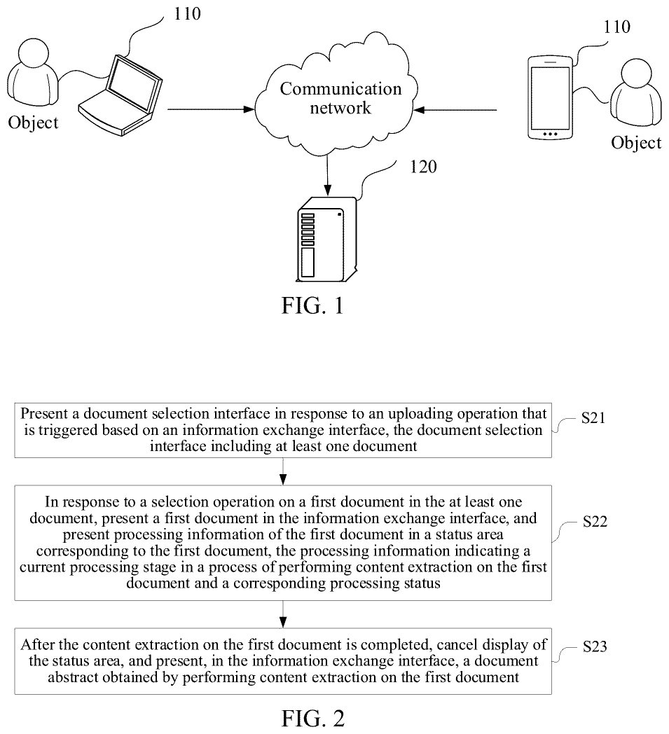

FIG. 1 is a schematic diagram of an application scenario according to some embodiments. The diagram of the application scenario includes two terminal devices 110 and one server 120.

In some embodiments, the terminal device 110 includes, but is not limited to, devices such as a mobile phone, a tablet computer, a laptop computer, a desktop computer, an e-book reader, an intelligent voice interaction device, a smart home appliance, and a vehicle terminal. A content extraction-related client may be installed on the terminal device, and the client may be software (such as a browser or instant messaging software), or a web page, an applet, or the like. The server 120 is a backend server corresponding to the software or web page, applet, or the like, or a server configured to perform content extraction. This is not limited herein. The server 120 may be an independent physical server, a server cluster or distributed system including multiple physical servers, or a cloud server providing basic cloud computing services such as a cloud service, a cloud database, cloud computing, a cloud function, cloud storage, a network service, cloud communication, a middleware service, a domain name service, a security service, a content delivery network (CDN), and a big data and an artificial intelligence platform.

A content extraction method according to some embodiments may be performed by an electronic device. The electronic device may be the terminal device 110 or the server 120. In some embodiments, the method may be performed by the terminal device 110 or the server 120 separately, or may be performed by the terminal device 110 and the server 120 together. For example, when the method is performed by the terminal device 110 and the server 120 together, a content extraction-related client may be installed on the terminal device 110, an object may trigger an uploading operation based on an information exchange interface in the client, and the client presents a document selection interface to the object in response to the uploading operation, to support the object to select a document from the document selection interface for uploading. In some embodiments, in response to a selection operation performed by the object on a first document in at least one document in the document selection interface, the client presents the first document in the information exchange interface, and transmits a document processing request for the first document to the server 120 via the terminal device 110. Further, the server 120 performs content extraction on the first document, generates a corresponding document digest, and feeds back the corresponding document digest to the client. The client presents the document digest to the object in the information exchange interface via the terminal device 120.

In addition, the server 120 is further configured to feed back processing information of the first document to the client in real time, so that the client presents the processing information in a status area corresponding to the first document via the terminal device 110. Moreover, the server 120 is further configured to feed back, in real time, an estimated completion time corresponding to a key processing stage to the client, so that the client presents, via the terminal device 110 in the status area, countdown information of the estimated completion time corresponding to the key processing stage when the current processing stage of the first document is the key processing stage.

In an exemplary implementation, the terminal device 110 may communicate with the server 120 through a communication network.

In an exemplary implementation, the communication network is a wired or wireless network.

FIG. 1 is merely an example for description. A quantity of terminal devices and a quantity of servers are not limited herein.

In some embodiments, when there are multiple servers, the multiple servers may form a blockchain, and the servers are nodes on the blockchain. According to the content extraction method in some embodiments, involved document-related data, for example, a document content of the first document, a generated slice digest, a document digest, a summarized document digest, an estimated completion time for a key processing stage corresponding to the first document, and answer messages of multiple rounds of question-answer, may be stored in the blockchain.

In addition, some embodiments may be applied to various scenarios, including but not limited to scenarios such as cloud technology, artificial intelligence, intelligent transportation, and driver assistance.

The following describes the content extraction method according to some embodiments with reference to the foregoing application scenario and the drawings. The foregoing application scenario is illustrated to facilitate understanding of the spirit and principles of various embodiments, and the implementations are not intended to be limiting.

FIG. 2 is an implementation flowchart of a content extraction method according to some embodiments. Taking a client as an execution subject as an example the method may include the following S21 to S23:
S21: Present a document selection interface in response to an uploading operation that is triggered based on an information exchange interface, the document selection interface including at least one document.

In some embodiments, different types of documents, for example, documents in formats such as WORD, PDF, EXCEL, and PPT, may be supported to be uploaded.

In addition, a document supporting uploading of various content may be uploaded. In conclusion, content included in the document may be in various data forms, for example, may be a text document (which may include a picture and a text), an audio document, or a video document. In terms of more detailed content classification, the content may be a public account article, an investigation report, a news report, a resume, a product analysis report, an English article, a legal file, a financial report, a paper, a teaching material, a novel, or the like. This is not limited herein.

In some embodiments, an object may trigger the uploading operation in the information exchange interface, to select, from the document selection interface, a first document on which content extraction needs to be performed. In some embodiments, the object may upload only one document at a time, and then perform digest extraction on only the document. In addition, the object may upload multiple documents at a time. When the object uploads multiple documents at a time, the object may separately perform digest extraction on each document, or may directly perform digest extraction on the whole of the multiple documents. Details are described below, and are not described herein again.

The information exchange interface according to some embodiments may be any exchange interface supporting a session function. In conclusion, the information exchange interface may be any session interface (for example, a chat interface) in the client, or may be a function interface that supports a session function and is specially used for document summarization, and may be referred to as a document summary interface.

In addition, the client in some embodiments includes but is not limited to forms such as an applet, an APP, and a web client.

An example in which the information exchange interface is a document summary interface is mainly used below. Certainly, the information exchange interface may be another session interface. Details are not described herein again.

In some embodiments, a document summarization function may be used only as a function in the client. In addition, the client may further support other functions such as AI drawing, AI copywriting generation, and AI outline generation. Based on this, the information exchange interface may be opened by the object based on a first interface in the client. An exemplary implementation is as follows:
Before S21, the client presents the information exchange interface in response to a document summarization operation triggered based on a first function control in the first interface, the information exchange interface including a default message and a document upload control, the default message being configured for presenting an example of a document summarization function, and the document summarization function indicating that a document digest is generated by performing content extraction on a document. The first interface, for example, may be referred to as a function discovery interface.

In this case, the information exchange interface presented may be understood as a function interface that supports a session function and is specially used for document summarization, namely, the document summary interface.

On this basis, the specific implementation of S21 is as follows: The client presents the document selection interface in response to an uploading operation triggered based on the document upload control in the information exchange interface.

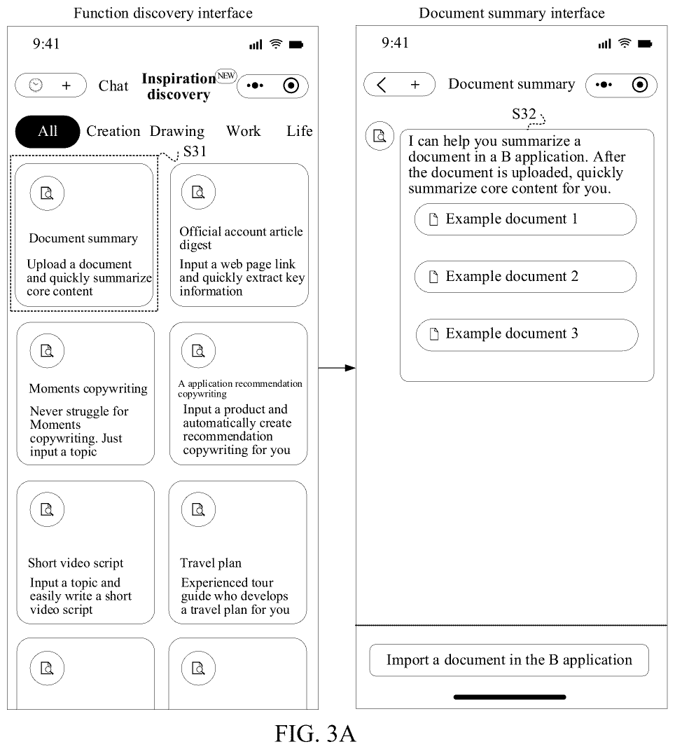

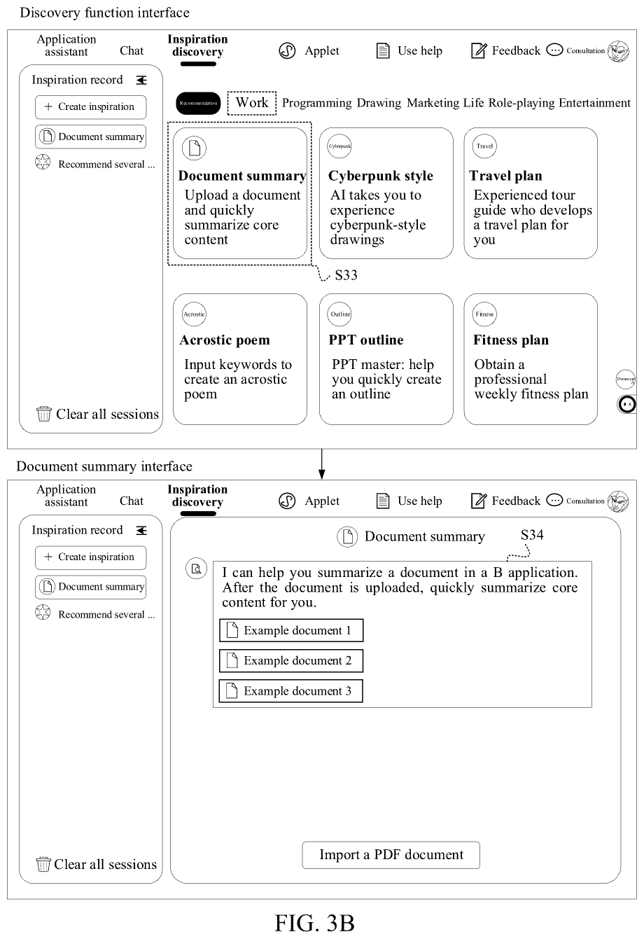

FIG. 3A is a schematic diagram of a function discovery interface and a document summary interface according to some embodiments. The function discovery interface includes multiple first function controls, for example, a document summary, an official account article digest, moments copywriting, an A application recommendation copywriting, a short video script, and a travel plan. The object may click/tap the document summary shown in S31 to trigger a document summarization operation, to present the document summary interface shown in FIG. 3A.

The document summary interface further presents a default message in a form of a message. As shown in a message box S32, a prompt object may upload a document, extract core content of the document, and generate a document digest. For example, in S32, text prompt information “I can help you summarize a document in a B application. After the document is uploaded, quickly summarize core content for you” is included.

In addition, a document upload control, that is, “import a document in the B application” shown in FIG. 3A, is displayed at the bottom (or may be disposed at another location) of the document summary interface. The object may click/tap the control, to enter a document selection interface.

FIG. 3B is a schematic diagram of a function discovery interface and a document summary interface according to some embodiments. Multiple first function controls included in the function discovery interface are: a document summary, a cyberpunk style, a travel plan, an acrostic poem, a PPT outline, a fitness plan, and the like. An object may click/tap the document summary shown in S33 to trigger a document summarization operation, to present the document summary interface shown in FIG. 3B.

Similar to FIG. 3A, a default message is presented in the document summary interface, as shown in a message box S34. In addition, a document upload control, that is, “import a PDF document” shown in FIG. 3B, is displayed at the bottom (or may be disposed at another location) of the document summary interface. The object may click/tap the control, to enter a document selection interface.

The trigger action that is listed above and that is performed on the control may be click/tap, or may be other actions such as touch and hold and double-click/tap. The same applies to the following. This is not limited herein.

In the foregoing implementation, the object may enter the information exchange interface via the function discovery interface, or may enter an interface related to another AI function via the function discovery interface. In addition, the document upload control is directly presented in the information exchange interface, so that the object directly uploads the document by operating the document upload control, thereby reducing complexity of an object operation, reducing an operation time, and further improving exchange convenience.

Certainly, the foregoing manner of entering the information exchange interface is only an example embodiment and is not limited thereto. In addition, the object may enter the information exchange interface in another manner. For example, the object directly opens a chat window (that is, may be used as an information exchange interface) with an AI digest summary robot in the client. This is not limited herein.

In some embodiments, the default message in the information exchange interface includes at least one example document. In some embodiments, when content extraction is not performed on the first document, the example document is in an interactive state. The interactive state means that a selection operation can be performed on any example document in an interactive state in the current information exchange interface.

Therefore, before S21, the object may further view a document digest of the example document, to further understand a document summarization function supported by the client. An exemplary implementation is as follows:

The client presents, in response to a selection operation on any example document in the at least one example document, a document digest corresponding to the any example document.

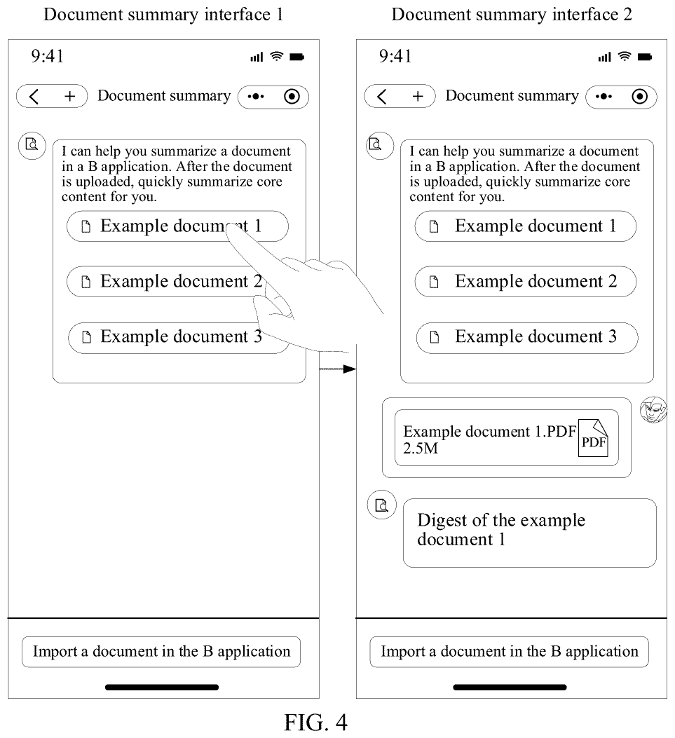

FIG. 4 is a schematic diagram of a process of viewing a document digest of an example document according to some embodiments. Example documents shown in a document summary interface 1 and a document summary interface 2 in FIG. 4 are in an interactive state. After an object selects an example document 1 in the document summary interface 1, the example document and a document digest of the example document may be presented in the document summary interface, as shown in the document summary interface 2 in FIG. 4. In some embodiments, the document digest herein is presented in a form of a message.

In the foregoing implementation, the example document is presented to the object based on a default message, and the object may learn of a document summarization function more directly and quickly based on the example document, so that an operation related to document summarization is performed, thereby improving exchange convenience.

In addition, the object may upload the first document based on the document upload control in the information exchange interface in addition to learning of the document summarization function based on the example document.

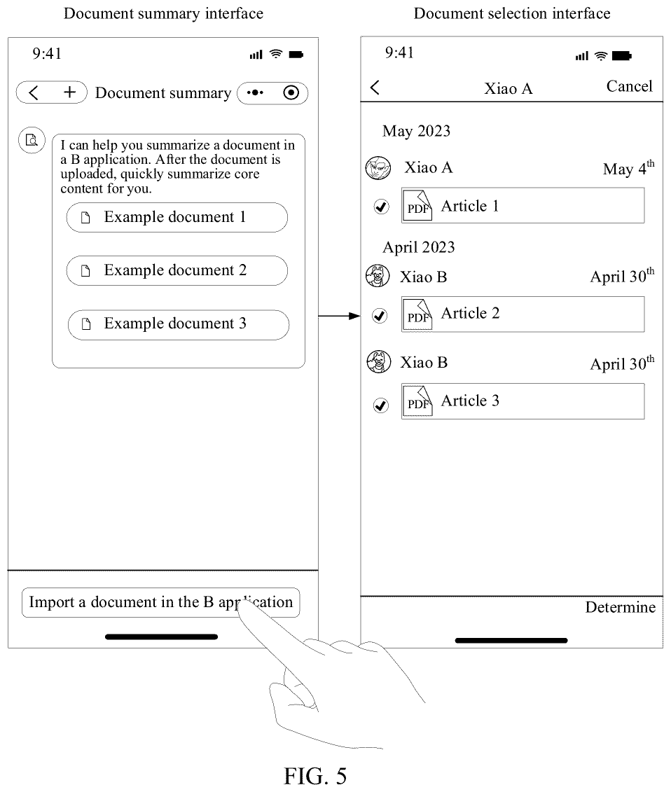

FIG. 5 is a schematic diagram of a document summary interface and a document selection interface according to some embodiments. A document upload control, that is, “import a document in a B application” shown in FIG. 5, is displayed at the bottom of the document summary interface shown in FIG. 5. An object may click/tap (or may be other actions such as touch and hold and double-click/tap) the control, to enter the document selection interface shown in FIG. 5.

The document upload control shown in FIG. 5 is an example of importing a local document in a client (namely, the B application). Three documents: an article 1, an article 2, and an article 3, are presented in the document selection interface shown in FIG. 5.

The three articles all belong to articles related to an object “Xiao A” to which the B application currently logs in, for example, an article 1 uploaded by Xiao A to the B application on May 4, 2023, and an article 2 and an article 3 transmitted by Xiao B to Xiao A on Apr. 30, 2023.

The object Xiao A may select at least one of the three articles as a first document, to perform content extraction on the first document.

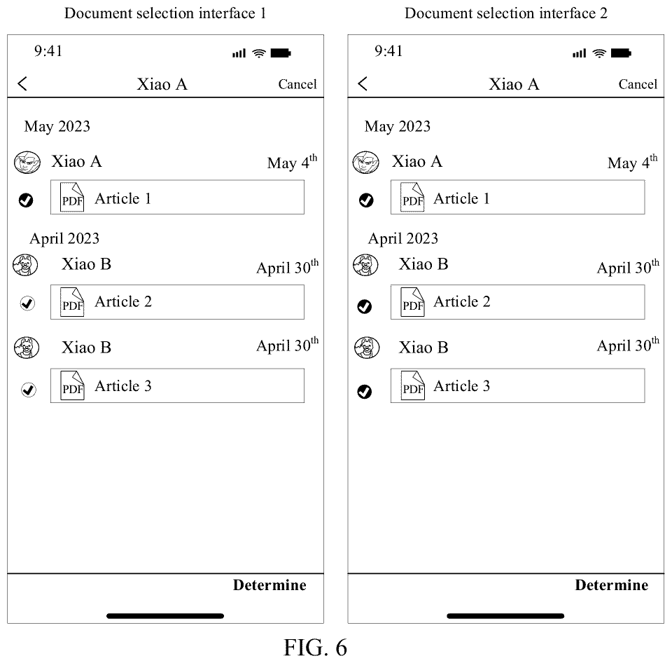

FIG. 6 is a schematic diagram of a document selection interface according to some embodiments. A document selection interface 1 indicates that an object Xiao A selects “article 1” as a first document, that is, only digest extraction needs to be performed on one first document. A document selection interface 2 indicates that the object Xiao A selects “article 1”, “article 2”, and “article 3” as first documents, that is, digest extraction needs to be performed on three first documents.

The document upload control shown in FIG. 3A, FIG. 4, and FIG. 5 is describe by using an example in which a local document of the client or a PDF document is imported. In addition, a document of another application may be imported, or a document of another type, a document link, or the like may be imported. In conclusion, the first document in some embodiments may be a document of any type uploaded through any channel. Details are not described herein again.

In addition, the foregoing listed document uploading manners are merely simple examples. In some embodiments, the document upload control may be not disposed in the information exchange interface. For example, the object may directly transmit the first document in a form of a message to a dialog window of the information exchange interface. In some embodiments, the object may invoke the document selection interface based on a voice instruction in the information exchange interface, to select the first document for uploading. Any manner of uploading the first document based on the information exchange interface is applicable. Details are not described herein again.

S22: In response to a selection operation on the first document in the at least one document, present the first document in the information exchange interface, and present processing information of the first document in a status area corresponding to the first document, the processing information indicating a current processing stage and a corresponding processing status in a process of performing content extraction on the first document.

In some embodiments, in operation S22, one or more first documents may be selected, the one or more first documents are presented, and processing information of a corresponding first documents is presented in a status area corresponding to each first document.

In some embodiments, the process of performing content extraction on the first document may be divided into multiple operations, and each operation may be considered as a processing stage. Therefore, the process of performing content extraction on the first document includes multiple processing stages.

For example, the processing stages in the content extraction process may include: uploading a document, extracting content information, processing picture content, processing text content, extracting a core idea, and sorting and combining digests.

Uploading a document is uploading all content (including one or more types of content such as a text, a picture, and a video) included in the document. Extracting content information is extracting specific information of one or more types of content, for example, a text, a picture, and a video, included in a document. Processing picture content may be understood as extracting text information in a picture (for example, recognizing picture content by using an optical character recognition (OCR) technology). Processing text content is, for example, performing slice processing on extracted text information, to obtain at least one text slice. Extracting a core idea may be understood as performing digest extraction on each text slice, to obtain a slice digest and the like corresponding to each text slice. Sorting and combining digests may be understood as performing content extraction on each obtained slice digest again, to obtain a document digest and the like corresponding to the first document. For details, refer to related descriptions on a server side. Repeated parts are not described again.

In conclusion, the foregoing processing stages may be classified into two types. One type is document uploading, that is, corresponding to the processing stage of “uploading a document”. The other type is document summarization, that is, corresponding to the foregoing processing stages of “extracting content information, processing picture content, processing text content, extracting a core idea, and sorting and combining digests”.

The several listed processing stages are merely simple examples. In addition, other processing stages such as processing video content and processing voice content may also be included. This is not limited herein.

A processing status corresponding to each processing stage may be being processed, completed, not processed yet, processing failed, or the like. In the state of being processed, a processing progress or the like may be further represented. This is not limited herein.

In conclusion, a document needs to be uploaded first, and content information included in the document may be extracted after the document is uploaded. If the extracted content information includes picture content, the picture content is processed. Further, if the extracted content information includes text content, the text content is processed, to extract core ideas from the processed content information. Finally, the extracted core ideas are sorted and combined to generate a document digest.

In some embodiments, execution of these processing stages consumes a period of time is considered. To reduce a feeling of waiting of the object, manage expectation of the object, and avoid a loss of the object in a digest generation process, in some embodiments, a status area for presenting related progresses of the processing stages is set in the information exchange interface. In some embodiments, in the process of performing content extraction on the first document, a current processing stage and a corresponding processing status that correspond to the first document are directly visible to the object in the status area, to enhance experience of the object.

The status area may be presented at a related location of the first document, for example, any location near the first document, for example, below, above, on a left side, on a right side, or the like of a message box of the first document. This is not limited herein.

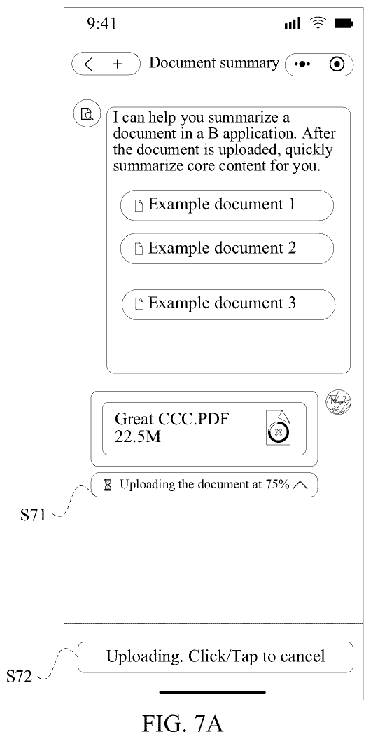

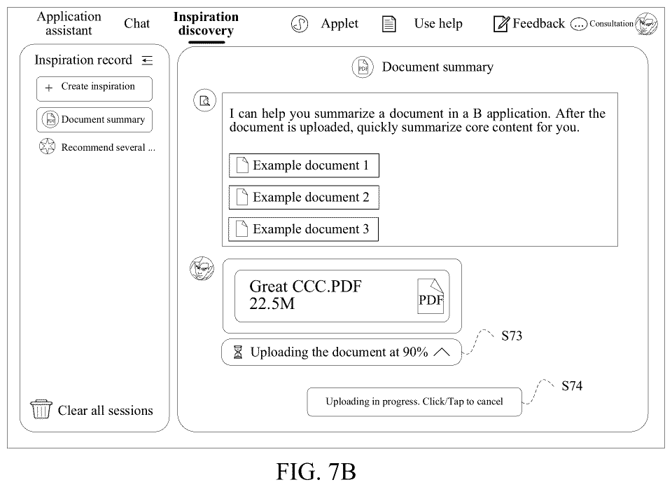

FIG. 7A is a schematic diagram of a status area according to some embodiments. S71 in FIG. 7A shows a status area in some embodiments. The first document being 22.5M PDF of “Great CCC” is used as an example. At a current moment, if a current processing stage corresponding to the first document is “uploading a document”, and an uploading progress (namely, a processing status) is 75%, the processing information “uploading the document at 75%” may be presented in the status area shown in S71.

FIG. 7B is a schematic diagram of a status area according to some embodiments. S73 in FIG. 7B shows a status area in some embodiments. Similar to the part S71 in FIG. 7A, the processing information “uploading the document at 90%” may be presented in the status area shown in S73, indicating that a current processing stage is uploading a document, and a corresponding processing status is that 90% of the document is uploaded.

In this process, if the object does not want to perform content extraction on the document, the object may cancel at any time. For example, in a process in which the object uploads the first document, the document upload control is updated from a style shown in FIG. 3B, FIG. 4, and FIG. 5 to a style shown in S72 or S74, that is, the object is prompted with “Uploading. Click/Tap to cancel”, and the object clicks/taps the control shown in S72 or S74, to cancel uploading of the first document at this time.

In some embodiments, the at least one example document is updated to a non-interactive state in a processing procedure after the first document is uploaded. The non-interactive state may indicate that an area in which a document is displayed cannot be operated. In this way, when the first document is processed, it may be ensured that the example document is not operated.

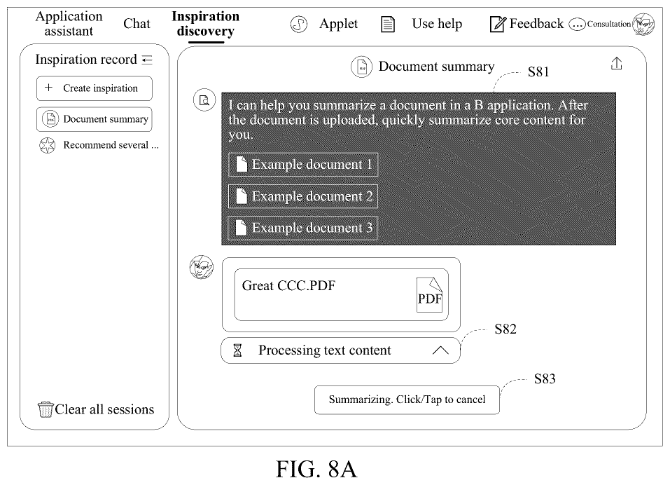

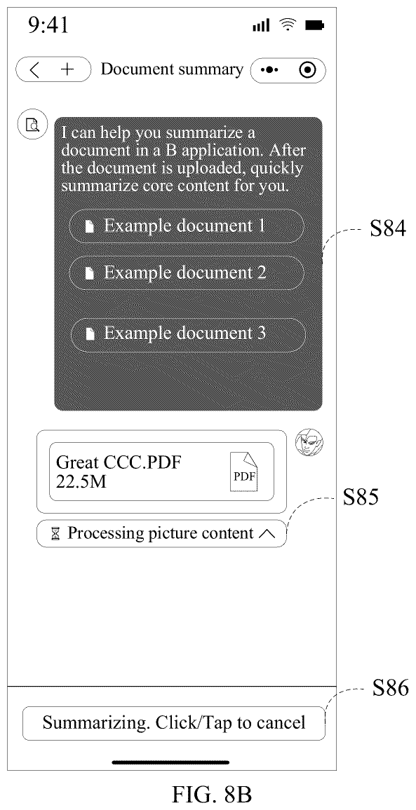

FIG. 8A is a schematic diagram of a default message and a status area according to some embodiments. Processing information “processing text content” in the status area S82 shown in FIG. 8A indicates that a current processing stage is processing text content, and a processing status is being processed. That is, the current processing stage belongs to a processing procedure after uploading is completed. In this case, the example document needs to be updated to a non-interactive state. The default message S81 shown in FIG. 8A indicates a non-interactive state.

FIG. 8B is a schematic diagram of another default message and another status area according to some embodiments. Processing information “processing picture content” in the status area S85 shown in FIG. 8B has the same meaning as S81 in FIG. 8A, and the default message S84 also indicates a non-interactive state.

In this process, if the object does not want to perform content extraction on the document, the object may cancel at any time. For example, in a process in which the object uploads the first document, the document upload control is updated from a style shown in FIG. 3B, FIG. 4, and FIG. 5 to a style shown in S83 or S86, that is, the object is prompted with “Summarizing. Click/Tap to cancel”, and the object clicks/taps the control shown in S83 or S86, to cancel uploading of the first document at this time.

In the foregoing implementation, a processing progress of the first document is presented to the object in real time in the status area, so that expectation of the object is effectively managed, and it is convenient for the object to intuitively learn of the progress. In this way, in some embodiments, the processing progress of the first document may be presented in real time.

In some embodiments, in an initial case, the status area is in a collapsed form, so that the object learns of a current processing stage in time.

In addition, if the object wants to learn of more processing stages in time, the status area may be switched to the expanded form. An exemplary implementation is as follows:

The clients switches the status area to an expanded form in response to an expansion operation triggered for the status area; and presents, in the status area in the expanded form, each processing stage in the process of performing content extraction on the first document and a respective processing status of each processing stage.

To facilitate the object to further quickly learn of the respective processing status of each processing stage, processing stages of different processing statuses may further be distinguished in different display styles, to present different sensory effects to the object.

In some embodiments, the different display styles may be different colors, different text styles, and different additionally added icons and patterns, and the like. This is not limited herein.

For example, when there is a processing stage in which processing fails, this type of processing stage is displayed in a red font, to play a role of warning; the processing stage that is being processed is displayed in a bold font, to emphasize the processing stage; and so on.

In some embodiments, forms of the status area may be divided into a collapsed form and an expanded form. In the collapsed form, only the current processing stage of the first document and the processing status corresponding to the current processing stage need to be presented in the status area, to ensure that the object learns of the current processing status of the first document in time.

In the expanded form, processing stages related to the process of performing content extraction on the first document and processing statuses respectively corresponding to the processing stages may be presented in the status area, to ensure that the object clearly learns of the complete processing procedure corresponding to the first document, for example, learns of a specific processing stage/specific processing stages that is/are completed, a specific processing stage/specific processing stages that is/are being processed, and a specific processing stage/specific processing stages that is/are not completed.

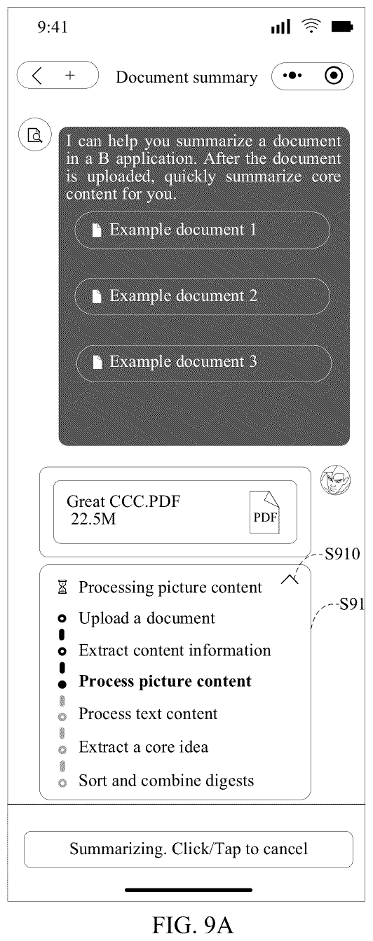

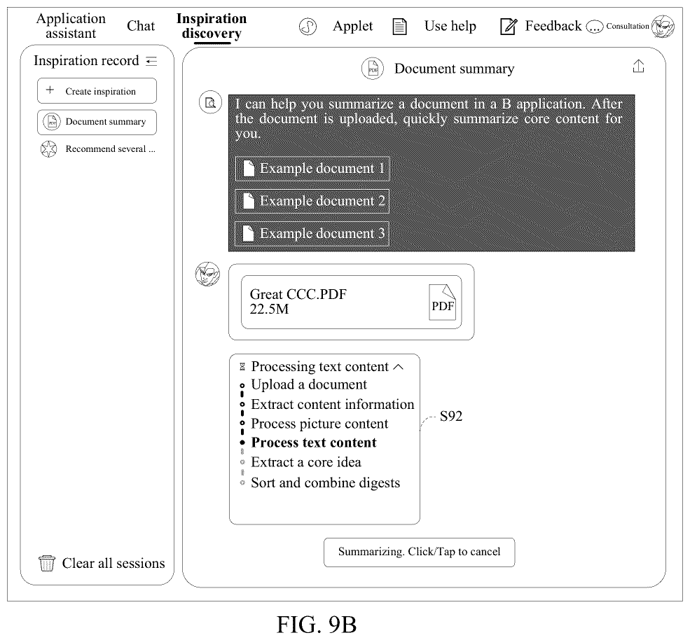

FIG. 9A is a schematic diagram of a status area in an expanded form according to some embodiments. As shown in the part S91 in FIG. 9A, in the expanded form, processing stages are displayed, and different processing statuses corresponding to these processing stages are indicated by using different text styles.

Uploading a document and extracting content information are in a state of being completed, processing picture content is in a state of being processed, and processing text content, extracting a core idea, and sorting and combining digests are in a state of being not processed yet.

In addition, the object may control, via a control shown in S910, whether a form of the status area is collapsed or expanded.

FIG. 9B is a schematic diagram of another status area in an expanded form according to some embodiments. As shown in the part S92 in FIG. 9B, in the expanded form, processing stages are displayed, and different processing statuses corresponding to these processing stages are indicated by using different text styles.

Uploading a document, extracting content information and processing picture content are in a state of being completed, processing text content is in a state of being processed, and extracting a core idea and sorting and combining digests are in a state of being not processed yet.

In the foregoing implementation, the status area is supported to have at least two forms: the expanded form and the collapsed form. In addition to facilitating the object to intuitively learn of the current processing progress of the first document, the object may further be supported to learn of, in time, another process required for performing content extraction on the first document, to reduce a feeling of waiting of the object, and avoid a loss of the object in a digest generation process.

In some embodiments, regardless of whether the status area is in the collapsed form or the expanded form, countdown information of an estimated completion time corresponding to a key processing stage is presented in the status area if the current processing stage of the first document is the key processing stage,
the key processing stage being at least one of the following: a preset processing stage and a processing stage in which the estimated completion time exceeds a preset time threshold.

That is, a key node in some embodiments may be one/more preset processing stages. Generally, more important and more complex processing stages may be preferentially set as key processing stages based on importance, complexity, or the like of the processing stages.

In some embodiments, a time threshold (namely, a preset time threshold) is preset. After estimating an estimated completion time corresponding to each processing stage of the first document, a server compares the estimated completion time with the preset time threshold, and uses a processing stage whose estimated completion time exceeds the preset time threshold as the key processing stage.

The preset time threshold may be flexibly set based on conditions such as an actual requirement, a model (for example, a semantic understanding model LLM) used during content extraction, and a ratio of an estimated completion time between the processing stages. This is not limited herein. For example, if an estimated completion time corresponding to most processing stages is 1 s to 2 s, and an estimated completion time of some processing stages is tens of seconds, the preset time threshold may be set to 10 s, and the like.

In some embodiments, the key processing stage may be comprehensively determined in the foregoing two manners.

In some embodiments, to enhance use experience of the object, reduce a feeling of waiting of the object, and make the object learn of, in time, time required for processing, countdown may further be displayed in some key processing stages based on the foregoing operation-by-operation display progress.

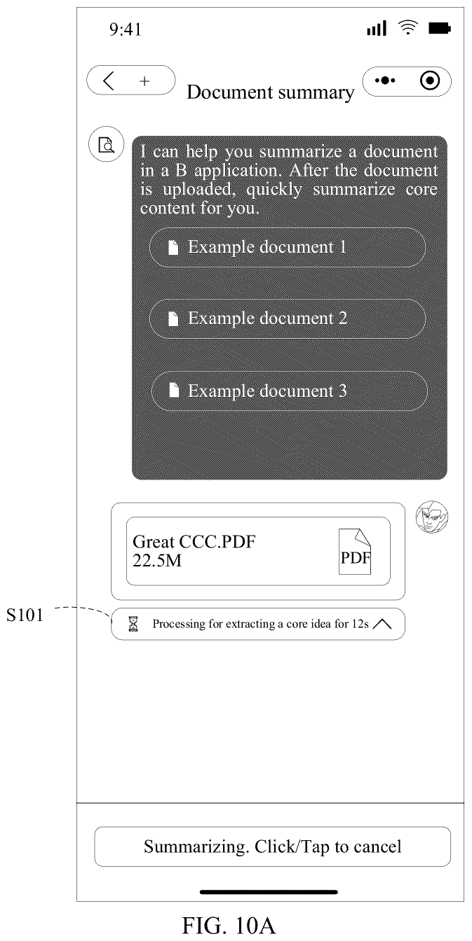

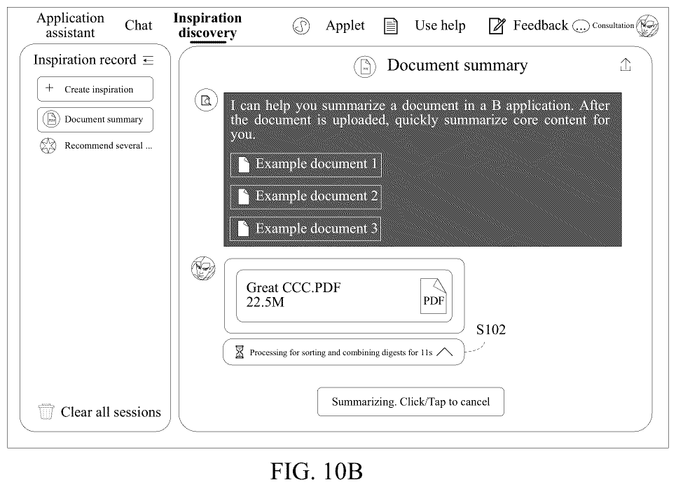

FIG. 10A is a schematic diagram of countdown information according to some embodiments. A current processing stage presented in a status area S101 shown in FIG. 10A is “extracting a core idea”, a processing status is “being processed”, and corresponding countdown information of an estimated completion time is 12 s. As time goes by, the countdown information also changes, for example, decreases to 11 s, 10 s, 9s . . . .

FIG. 10B is a schematic diagram of other countdown information according to some embodiments. A current processing stage presented in a status area S102 shown in FIG. 10B is “sorting and combining digests”, a processing status is “being processed”, and corresponding countdown information of an estimated completion time is 11 s. As time goes by, the countdown information also changes, for example, decreases to 10 s, 9 s, 8 s.

The countdown information listed in FIG. 10A or FIG. 10B is presented in the status area in the collapsed form. In addition, the countdown information of the key processing stage may be presented in the status area in the expanded form.

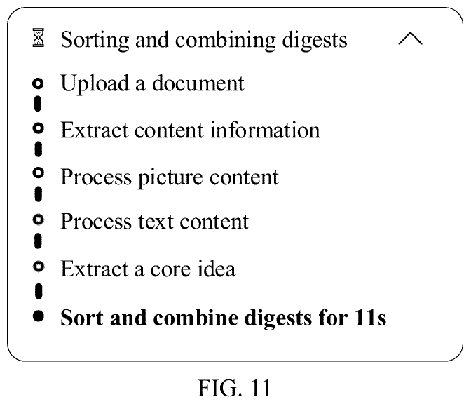

FIG. 11 is a schematic diagram of still other countdown information according to some embodiments. As shown in FIG. 11, completed processing stages are: uploading a document, extracting content information, processing picture information, processing text information, and extracting a core idea. A processing stage that is being processed is: sorting and combining digests. The processing stage is a key processing stage, and countdown information may be further presented, for example, 11 s shown in FIG. 11. As time goes by, the countdown information may gradually decreases to 10 s, 9 s, 8 s . . . .

In the foregoing implementation, duration may be calculated before some links that are complex or important, or consume a long time, and countdown is presented, to ensure that the object learns of the current processing procedure of the first document and a remaining processing time in time, so that the progress of the processing procedure can be notified in time, to reduce the feeling of waiting of the object.

No anomaly occurs in the content extraction process listed in FIG. 9A, FIG. 9B, FIG. 10A, FIG. 10B, or FIG. 11. However, in an actual application process, processing may fail in a specific processing stage/specific processing stages.

In some embodiments, a re-upload control may be presented when the first document fails to be uploaded (that is, processing fails in the processing stage of uploading the document), the object may re-trigger an uploading operation based on the re-upload control, and the client re-uploads the first document in response to a re-uploading operation triggered based on the re-upload control.

In some embodiments, upload failure prompt information may be further presented. The upload failure prompt information may be in a form of a control, a pop-up window, or the like, or may be directly presented in the status area (namely, corresponding processing information when processing fails in the processing stage of uploading the document, which may also be referred to as the upload failure prompt information), or may be a combination of the foregoing two or more cases. This is not limited herein. When the upload failure prompt information is in a form of a control, the upload failure prompt information is the re-upload control in some embodiments, and the object may trigger an operation of re-uploading the document based on the re-upload control.

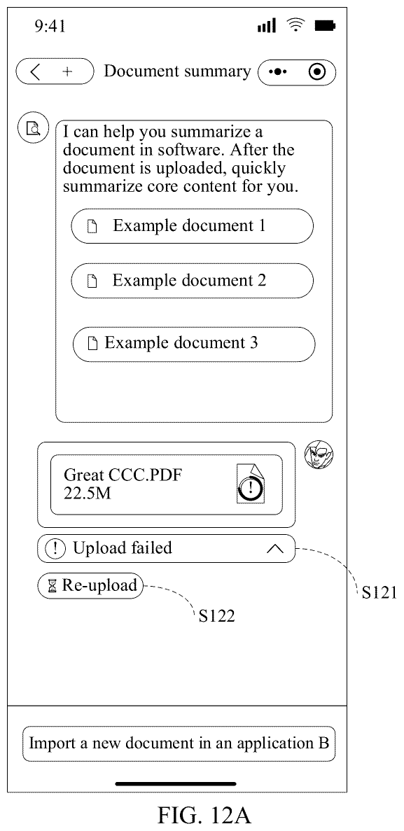

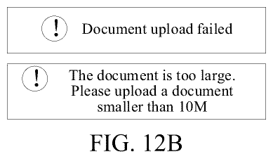

FIG. 12A is a schematic diagram of upload failure prompt information according to some embodiments. The object “upload failed” is prompted in the status area shown in S121 when uploading of the first document fails. In addition, the “re-upload” control is further presented below the status area, as shown in S122. S121 and S122 may be considered as a representation form of the upload failure prompt information in some embodiments. The object may click/tap the re-upload control shown in S122, to re-upload the first document.

A presentation manner of upload prompt information listed in FIG. 12A is merely a simple example, and may be another form such as a pop-up window. In addition, a cause for an upload failure may be further prompted. FIG. 12B is a schematic diagram of other upload failure prompt information according to some embodiments. FIG. 12B lists two types of upload failure prompt information via the control as an example. For example, only an object “document upload failed” may be prompted, and a cause for the uploading failure may also be prompted. For example, “The document is too large. Please upload a document smaller than 10M”.

In addition to the foregoing listed anomaly of the document uploading node, another node may also have an anomaly. If a picture content node fails to be processed, processing information indicating the failure may be directly presented in the status area.

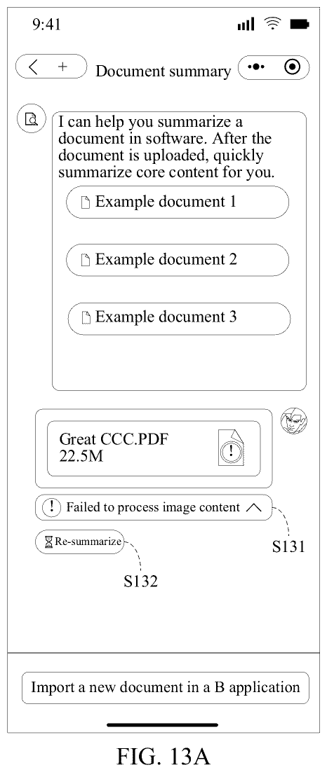

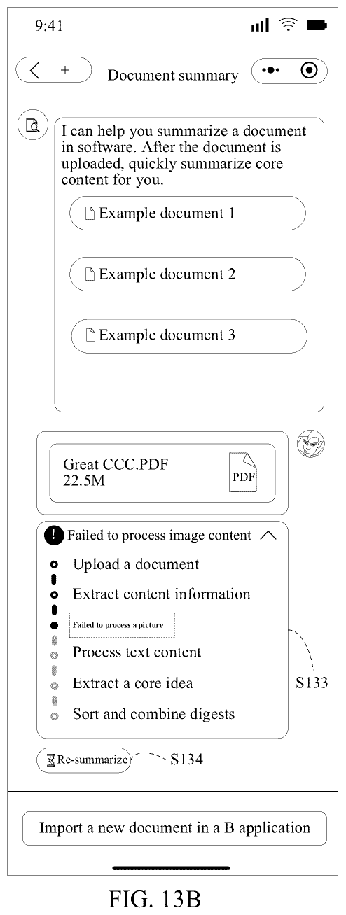

FIG. 13A is a schematic diagram of a processing stage anomaly according to some embodiments. A status area in FIG. 13A is in a collapsed form. Processing information shown in S131 indicates that a processing status of the node for processing picture content is: processing failed. In this case, a re-summarization control may be presented below the status area, as shown in S132, and the object may click/tap the control to re-perform content extraction on the first document.

FIG. 13B is a schematic diagram of another processing stage anomaly according to some embodiments. A status area in FIG. 13B is in an expanded form. A processing status corresponding to the node for processing picture content in the status area shown in S133 is: failed to process a picture. After this operation fails, a subsequent digest summary operation cannot be continued. In this case, a re-summarization control may also be presented below the status area, as shown in S134, and the object may click/tap the control to re-perform content extraction on the first document.

In FIG. 13A or FIG. 13B, the processing stage of processing picture content is used as an example, and the same processing manner is used when an anomaly occurs in another processing stage. Details are not described herein again.

In the foregoing implementation, the object is supported to quickly re-upload the document via the re-upload control, and re-perform content extraction on the first document via the re-summarization control when uploading fails or processing of another node is abnormal, to help, when a selection anomaly occurs, reselect a document from which a digest needs to be generated, thereby improving operation convenience of selecting the document.

In some embodiments, after each processing stage in the process of performing content extraction on the first document and a respective processing status of each processing stage are presented in the status area in the expanded form, the object may further view specific processing statuses of these processing stages.

A processing result of the any target processing stage is presented for a target processing stage in a target processing status in each processing stage in response to a selection operation on any target processing stage.

The target processing status may be any specified processing status, for example, completed, being processed, or processing failed.

Generally, the object wants to view a processing result corresponding to a completed processing stage, or wants to view a failure cause corresponding to a processing stage in which processing fails. Therefore, an exemplary implementation is as follows: The target processing status includes at least one of completion and processing failure; and the processing result includes at least one of a failure cause and a document adjustment suggestion when a processing status of the any target processing stage is processing failure.

In some embodiments, the processing result may be presented in a floating layer, a pop-up window, a new page, a specific area on a current page, and the like. This is not limited herein. A simple example is provided below by using a floating layer as an example.

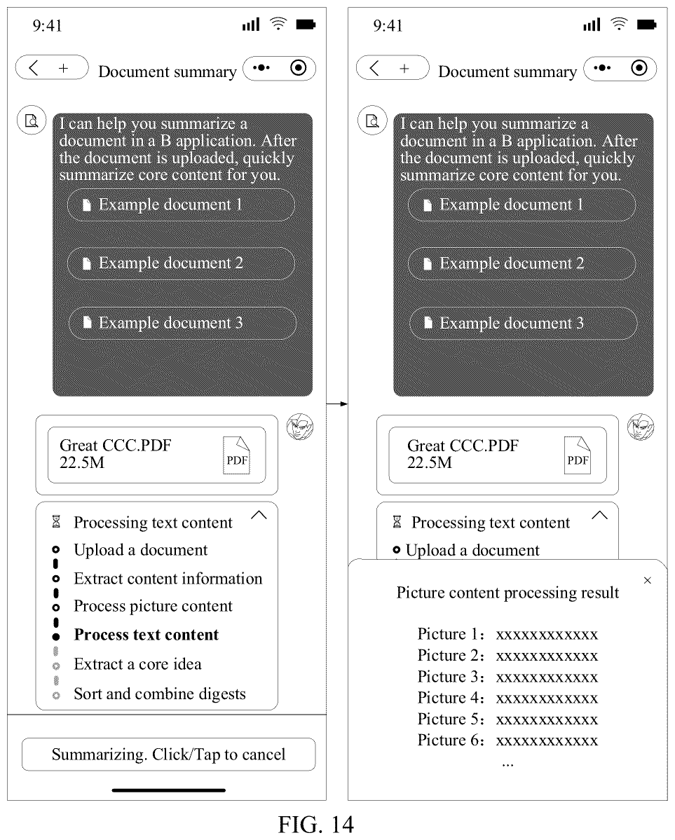

FIG. 14 is a schematic diagram of a processing result according to some embodiments. For example, currently completed processing stages include uploading a document, extracting content information and processing picture content, the object selects the target processing stage “processing picture content”, and can view a picture content processing result corresponding to the first document, and the processing result is text information extracted from each picture.

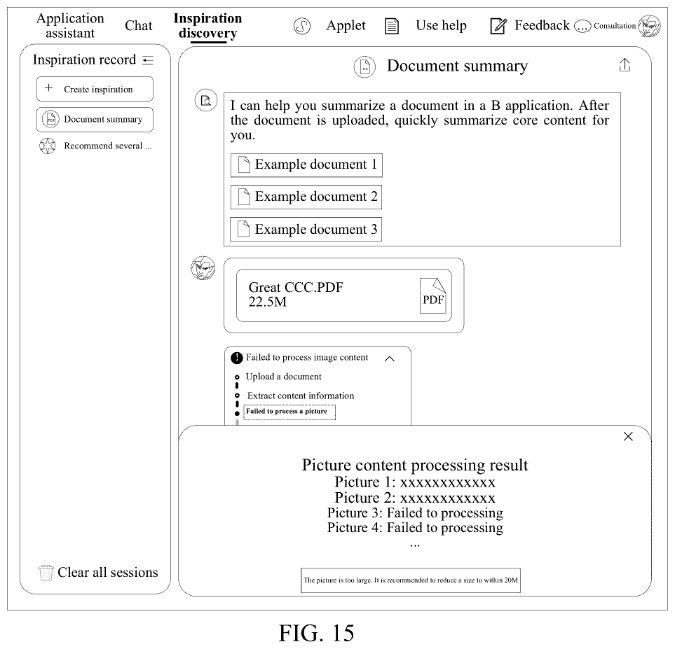

FIG. 15 is a schematic diagram of another processing result according to some embodiments. For example, a current processing stage in which processing fails is processing picture content, the object selects the target processing stage “processing picture content”, and can view a picture content processing result corresponding to the first document, and the processing result is text information successfully extracted from the picture and a picture on which processing fails. In addition, the failure cause and the document adjustment suggestion may be further presented, for example, “The picture is too large, and it is suggested to be adjusted to within 20M” in FIG. 15.

The several manners of presenting a processing result listed above are merely simple examples. In addition, other presentation manners of a processing result are also applicable. Details are not described herein.

In the foregoing implementation, the processing result may be directly viewed based on the processing stage shown in the status area, to quickly present a related processing procedure and result of the document.

S23: After the content extraction on the first document is completed, cancel display of the status area, and present, in the information exchange interface, a document digest obtained by performing content extraction on the first document.

In some embodiments, a document digest may be output in various forms, which includes, but is not limited to, forms such as a text, a picture (a flowchart, a mind map, and the like), and a table.

In some embodiments, when processing (namely, content extraction) on the first document is completed, it indicates that content extraction is completed, and the document digest of the first document is obtained. The document digest is a document digest generated by summarizing overall content of the first document. The object may quickly learn of main content (which may also be referred to as summarized content) of the first document by reading the document digest.

In conclusion, in the solution of some embodiments, an exchange solution for generating a digest corresponding to a document may be provided, to help select the document and generate the digest of the document, so as to conveniently provide summarized content of the document, and further improve information presentation efficiency and reading efficiency.

In addition, considering that processing on the first document is completed, that is, it indicates that each processing stage is completed, the processing information does not need to be displayed in the status area, and display of the status area may be canceled.

In some embodiments, the document digest may be presented in the information exchange interface in any manner. For example, the document digest may be presented in a form of a message. In some embodiments, a new message box is directly generated in the information exchange interface, and the generated document digest is completely presented in the message box. In some embodiments, to enhance experience of the object, document digests corresponding to the first document may be streaming-outputted in a form of a message in the information exchange interface, so that the object feels that these document digests are gradually outputted.

In addition, after content extraction on the first document is completed, the at least one example document may be further updated to an interactive state. When the document digest is streaming-outputted, the at least one example document may be updated to an interactive state before/when the document digest is outputted; or after the document digest is completely outputted, the at least one example document may be updated to an interactive state.

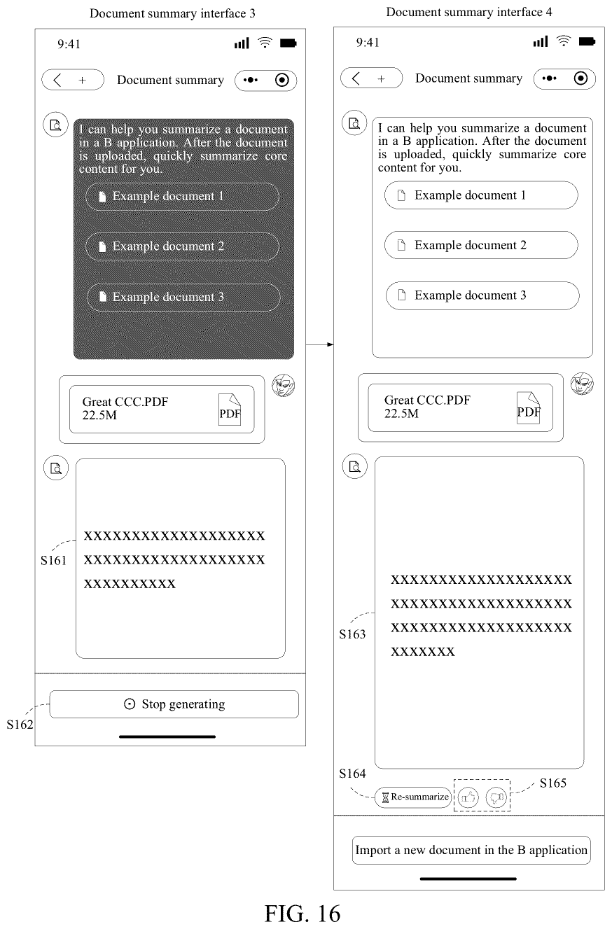

Taking the streaming output manner listed above as an example, FIG. 16 is a schematic diagram of a first document digest according to some embodiments. As shown in a document summary interface 3 and a document summary interface 4 in FIG. 16, a document digest shown in a message box S161 in the document summary interface 3 is not completely outputted, and a document digest shown in a message box S163 in the document summary interface 4 indicates a completely outputted result. When the document digest is not completely outputted, “Summarizing. Click/Tap to cancel” shown above is updated to “Stop generating” shown in S162, and the object may randomly click/tap a control shown in S162, to pause outputting the document digest.

In addition, after the document digest is completely outputted, the example document may be updated from a non-interactive state shown in the document summary interface 3 to an interactive state shown in the document summary interface 4.

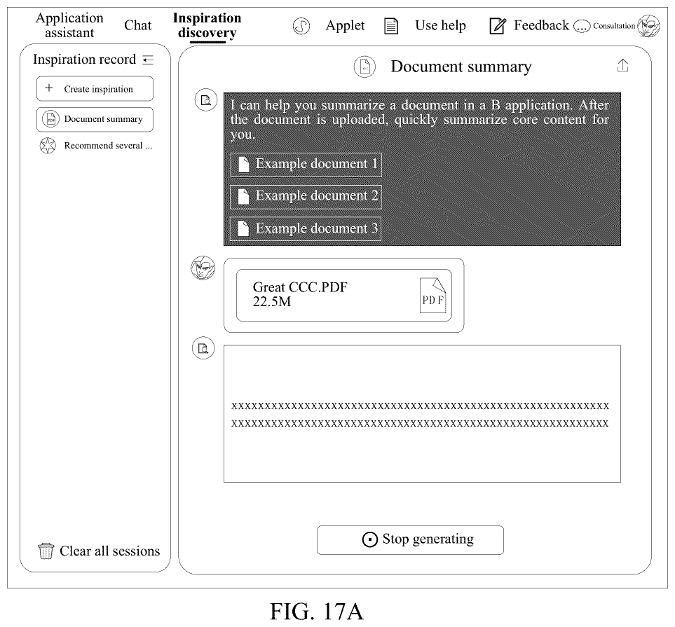

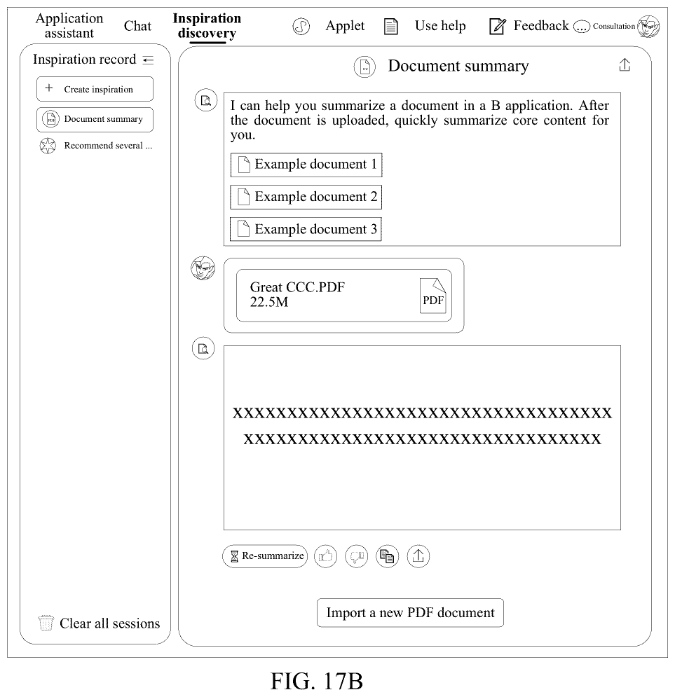

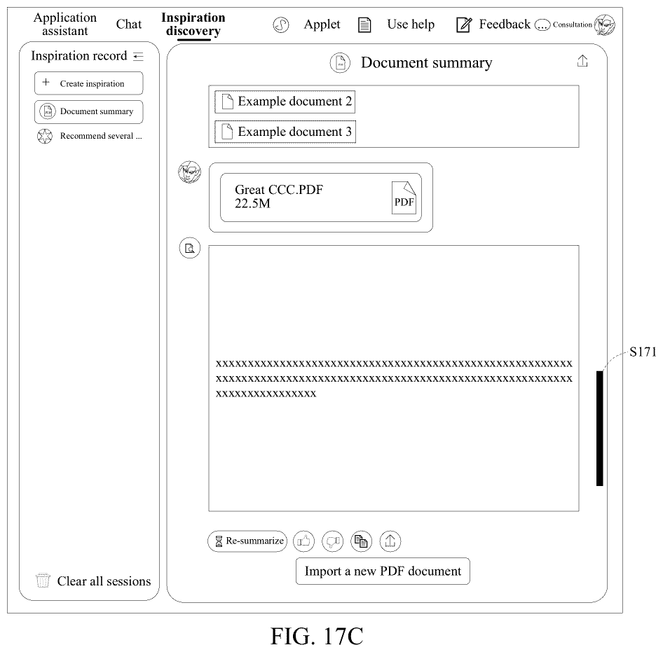

FIG. 17A is a schematic diagram of a second document digest according to some embodiments. FIG. 17A shows an example of a document summary interface presented when a document digest is being outputted. Similar to the document summary interface 3 in FIG. 16, the document digest in the message box is not completely outputted, and the object may randomly click/tap “Stop generating”, to pause outputting the document digest.

FIG. 17B is a schematic diagram of a third document digest according to some embodiments. FIG. 17B shows an example of a document summary interface presented when a complete document digest is outputted. Similar to the document summary interface 4 in FIG. 16, the document digest in the message box is completely outputted, the re-summarization control may be presented below the message box, and the object may click/tap the control, to re-perform content extraction on the first document.

When there is a large amount of content of the document digest, if the document digest exceeds one screen, the document digest may be displayed in a scrolling manner, and a bottom button “import a new PDF document” is in a floating state. FIG. 17C is a schematic diagram of a fourth document digest according to some embodiments. A scroll bar may be presented on a right side of a document summary interface, namely, S171. The object may slide a screen up and down a screen by pulling the scroll bar, to view a complete document digest.

In some embodiments, the document digest may be presented in a form of a message. In some embodiments, the object may generate different document digests for the same document for multiple times. An exemplary implementation is as follows:
A re-summarization control for the first document is presented at a first related location of the document digest; and then the object may click/tap the re-summarization control, and the client re-performs content extraction on the first document in response to a trigger operation on the re-summarization control, and after the content extraction is re-completed, presents a new document digest at an original message corresponding to the document digest.

The first related location may be any location near the document digest, for example, below, above, on a left side, on a right side, or the like of a message box of the document digest. This is not limited herein.

In some embodiments, when the complete document digest is outputted, the re-summarization control may be presented at the first related location of the document digest. Still using FIG. 16 as an example, S164 in the document summary interface 4 shown in FIG. 16 is an example of the re-summarization control in some embodiments. The object may click/tap the control, to repeat the content extraction process. In some embodiments, the content extraction process may include multiple processing stages. When content extraction is re-performed on the first document, only some nodes in the multiple processing stages may be re-performed, or all nodes in the multiple processing stages may be repeatedly performed. When some nodes in the multiple processing stages are re-performed, mainly at least the last processing stage is repeated, and several processing stages before the last processing stage may be repeated.

In some embodiments, considering that digest extraction of the same document for multiple times can be performed, the object may further switch to view the document digests generated for the several times.

An exemplary implementation is as follows:
A digest switching control is presented at a second related location of the document digest; and the object may switch the document digest based on the digest switching control to view, and the client switches and displays, in response to a switching operation triggered based on the digest switching control, multiple document digests that correspond to the first document and that are in the original message.

In some embodiments, the multiple document digests corresponding to the first document are document digests generated by summarizing each time when the object performs digest summarization on the first document for multiple times in the foregoing manner. These document digests may be displayed in the same message box, and are switched and displayed via the digest switching control.

The second related location may be any location near the document digest, for example, below, above, on a left side, on a right side, or the like of a message box of the document digest. This is not limited herein. The second related location may be the same as or close to the first related location, or may be different from the first related location.

First, in the process of re-performing content extraction on the first document, the status area may be further presented in any manner listed in some embodiments, and presentation of the status area is canceled after content extraction is completed. The newly generated document digest may be presented in a form of a new message, may be updated based on an original message presented when the document digest is previously generated, or the like.

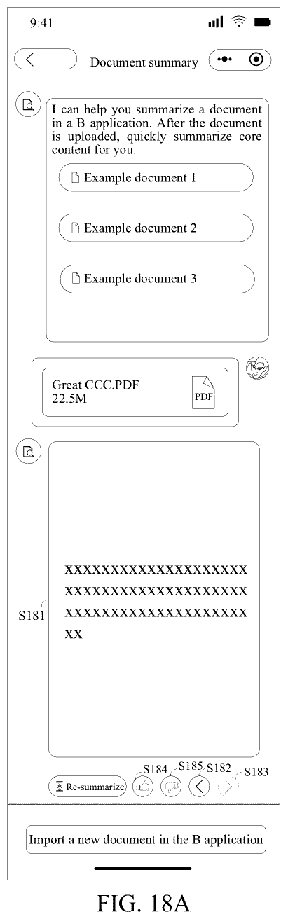

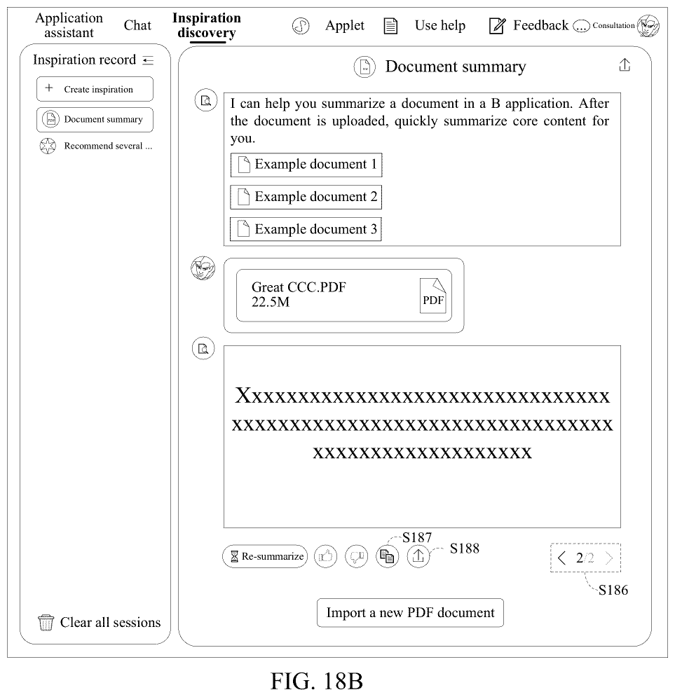

Taking update performed based on an original message as an example, FIG. 18A is a schematic diagram of a digest switching control according to some embodiments. The newly generated document digest may still be presented in a message box shown in S181 when digest re-summarization is performed. The message box is generated when digest summarization is performed on the first document for the first time. The digest switching control may be presented at locations shown in S182 and S183 when the new document digest is generated. The digest switching control shown in S182 in FIG. 18A is configured to view a previously generated document digest of a currently displayed article digest. The digest switching control shown in S183 is configured to view a next generated document digest of the currently displayed article digest.

When the message box shown in S181 presents a latest generated document digest, the digest switching control shown in S183 is in a non-interactive state, that is, it indicates that the currently displayed article digest is the latest generated document abstract, and S183 cannot be operated.

FIG. 18B is a schematic diagram of another digest switching control according to some embodiments. The digest switching control may be presented at a location shown in S186, and the object may view a previously/next generated document digest of the currently displayed article digest. 2/2 indicates that a total of two document digests are generated for the first document, and the currently presented document digest is generated for the second time.

In the foregoing implementation, the object is supported to perform content extraction on the first document for multiple times, and a new document digest is quickly obtained via the re-summarization control, until a more satisfying digest is obtained. In addition, the object is supported to switch to view a document digest generated each time.

In some embodiments, the object can evaluate and feed back quality of the generated document digest. An exemplary implementation is as follows:

A feedback control for evaluating summarization quality of the document digest is presented at a third related location of the document digest; and the client presents a corresponding evaluation result in response to an evaluation operation that is triggered based on the feedback control.

For example, a positive feedback and a negative feedback are respectively generated by likes and dislikes. In some embodiments, the object may score the document digest, or light up different quantities of small stars to give a feedback. This is not limited herein. In addition, when multiple document digests are generated for the same first document, the object is supported to evaluate each document digest.

FIG. 18A is still used as an example. S184 in FIG. 18A is an example of a positive feedback control according to some embodiments. When the object is satisfied with the generated document digest, positive evaluation may be given by likes, and an evaluation result in forms such as a quantity of current likes or successful likes may be presented. S185 is an example of a negative feedback control according to some embodiments. When the object is not satisfied with the generated document digest, negative evaluation may be given by dislikes, and an evaluation result in forms such as a quantity of current dislikes or successful dislikes may be presented.

The feedback control listed in FIG. 18A is merely a simple example. In addition, a feedback control in another form is also applicable. Details are not described herein.

In the foregoing implementation, the object is supported to evaluate the generated document digest, and the content extraction model may be fine-tuned based on the object feedback, to improve accuracy of generating the document digest.

According to the content extraction method in some embodiments, based on a content digest capability, different upper-layer applications may be encapsulated in different industries. For different file scenarios in different industries, more product forms may be derived after model fine tuning is performed and upper-layer product applications are encapsulated. Specific application scenarios include, but are not limited to, some or all of the following:
a financial report assistant: performing financial report digest extraction; a paper assistant: performing academic paper extraction; a teaching material assistant: performing teaching material digest extraction; and a novel assistant: performing novel digest extraction, extracting a novel character relationship, and the like.

In conclusion, the content extraction method in some embodiments supports performing digest extraction on various documents, the extracted digests are not limited to a text in a paragraph form, and may also be in a form of a picture, a table, or another form. This is not limited herein.

Further, the content extraction method in some embodiments also supports performing multiple rounds of question-answer based on the generated document digest. Generation of the document digest may be considered as the first round of session/question-answer. In this case, the object is supported to answer, based on the content of the document, a subsequently asked question or repeatedly modify the document digest from the second round of session.

An exemplary implementation is as follows: In addition to presenting, in the information exchange interface, the document digest obtained by performing content extraction on the first document, an input box may be further presented; and the object may input a problem or a modification instruction for the document digest based on the input box.

This input box can be presented in any area of the information exchange interface, for example, at the bottom of the information exchange interface.

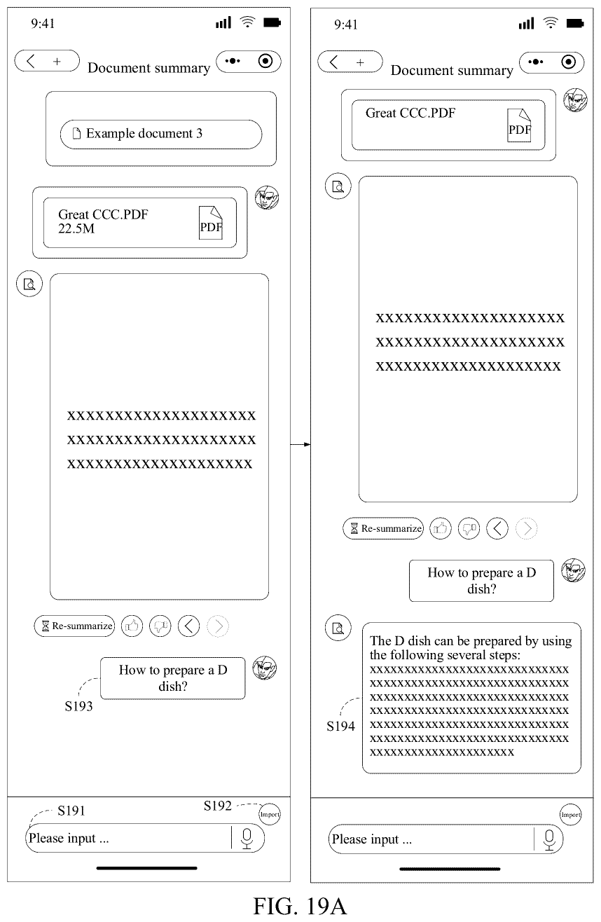

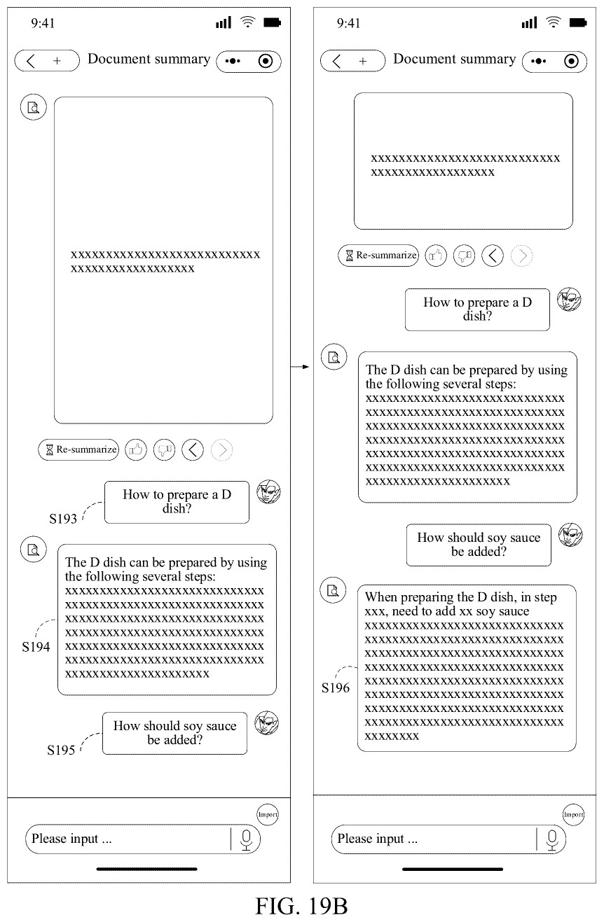

In some embodiments, when there is a document upload control in the information exchange interface (namely, the document summary interface) used for document summarization, the input box may be presented at the location of the original document upload control, as shown in S191 in FIG. 19A; and the original document upload control is collapsed into a small icon, and is presented at another location, as shown in S192 in FIG. 19A.

In addition, considering that the information exchange interface in some embodiments only needs to support a session function, the information exchange interface may be any session interface. Therefore, in addition to using the foregoing manner to ask questions about the document content, questions can also be asked about non-document content (that is, common AI-based question-answer).

Consequently, the input box may be an existing input box that already exists in the session interface. The object may input a first question for the document content in the input box, or may input a second question for non-document content.

A presentation time of the input box is not limited herein. For example, the input box may be presented simultaneously with the document digest in the information exchange interface, or may be presented after the object triggers a preset operation (such as a target gesture or a voice instruction) in the information exchange interface. After the input box is presented, the object may input the first question, the second question, a modification instruction, and the like through a text, a voice, and the like. This is not limited herein.

A question-answer scenario related to the first question is first described below.

In some embodiments, the client presents, in response to the first question that is inputted based on the input box for the document digest, an answer message corresponding to the first question, the answer message being any one of the following:
a message that is generated based on the first question and content that is related to the first question in the first document, a message that is generated based on a search result related to the first question, and a message for a predetermined expression indicating that no answer is provided.

In conclusion, when the object inputs the first question, if document content of the first document can answer the question, the answer message is directly generated based on related content in the first document; or if document content of the first document has a related part, but the question cannot be answered, a search plug-in can be started, and an answer message is generated based on a search result; or if the document content of the first document has no related part, a predetermined expression is returned, indicating that no answer is provided.

FIG. 19A is a schematic diagram of a question-answer scenario for a document digest according to some embodiments. An input box S191 is displayed at the bottom of the information exchange interface, and the object may input the first question based on the input box. For example, if the object inputs the first question “How to prepare a D dish?” shown in S193, if there is content related to “How to prepare a D dish?” in the first document, and an answer message may be directly generated based on the related content in the first document, an answer message shown in S194 may be presented.

Both the first question and the answer message may be presented in a form of a message.

In addition, the object may upload a new first document based on the document upload control shown in S192, to performing content extraction on the new first document.

Further, the foregoing may be recorded as the second round of session. Based on this, the object may continue to ask a question, and perform the third round of session, even the fourth round of session, the fifth round of session . . . .

FIG. 19B is a schematic diagram of another question-answer scenario for a document digest according to some embodiments. Based on FIG. 19A, the object inputs the first question “How should soy sauce be added?” shown in S195. In this case, context rewriting may be performed on the first question S195 with reference to the first question (that is, S193) before the first question shown in S195 and the answer message (that is, S194). For example, a rewritten question is “How should soy sauce be added in a process of preparing a D dish?”. If the first document includes related content of the question “How should soy sauce be added in a process of preparing a D dish?”, an answer message shown in S196 may be directly generated based on the related content in the first document.

The following describes a modification scenario:
In some embodiments, the client presents, in response to a modification instruction that is inputted based on the input box for the document digest, a modified document digest corresponding to the modification instruction.

The modification instruction may be proposed for content, a word count, a person name, and the like of the document digest. For example, 300 words are adjusted to 200 words, and a first person is adjusted to a third person. In addition, the modified document digest corresponding to the modification instruction in some embodiments may be presented in an original message box corresponding to the document digest previously generated for the first document, or may be presented in a new message box. This is not limited herein.

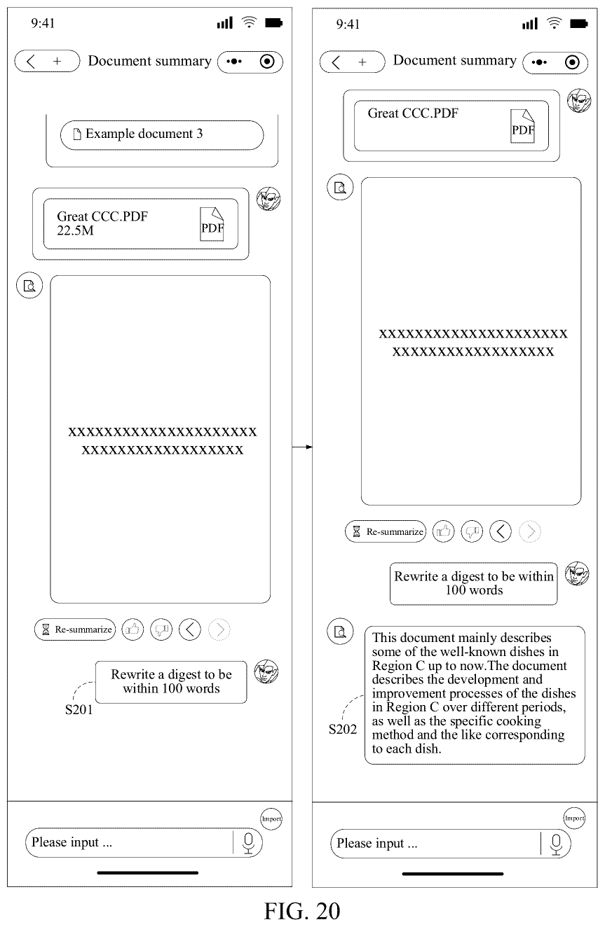

FIG. 20 is a schematic diagram of a modification scenario for a document digest according to some embodiments. If the object inputs a modification instruction shown in S201, a word count of the currently generated document digest is reduced to within 100 words, and the generated modified document digest may be presented in a new message box, as shown in S202.

The several processes of performing question-answer or modification based on the document digest listed in FIG. 19A, FIG. 19B, or FIG. 20 are merely simple examples. In addition, another implementation process having a same function is also applicable. This is not limited herein.

In the foregoing implementation, in some embodiments, after the digest is outputted, asking a question is further supported according to content in the digest, and the model further generates answer content, to support the object to repeatedly modify the digest or ask a question about the content in the digest. This can enhance interactivity, and facilitate the object to view the first document more quickly, to obtain effective information.

An example in which question-answer is performed on document content is used in the foregoing. If the information exchange interface further includes a second question inputted for non-document content, an exemplary implementation of an answer message is as follows:

The first question and the answer message corresponding to the first question are presented in a first message style; and the second question and an answer message corresponding to the second question are presented in a second message style.

That is, a common question-answer scenario (non-document content question-answer) is distinguished from a document question-answer scenario by using different message styles. In some embodiments, different message styles may be different message fonts (for example, fonts of different colors or fonts of different sizes), different message boxes (for example, different message bubbles), and the like. This is not limited herein.

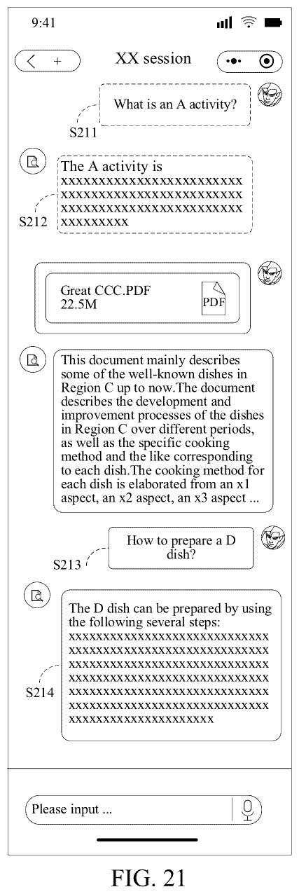

FIG. 21 is a schematic diagram of a presentation style of a question and an answer message according to some embodiments. Clearly, S211 in FIG. 21 is a second question unrelated to document content, S212 is an answer message corresponding to the question, and message boxes in a dashed line form are used for S211 and S212. S213 in FIG. 21 is a first question related to the document content, S214 is an answer message corresponding to the question, and message boxes in a solid line form are used for S213 and S214. Different message styles are reflected by message boxes with different lines.

Before performing distinguishing by using different message styles, a client further needs to distinguish, by using particular logic, which question belongs to a first question and which question belongs to a second question in questions inputted by an object.

In some embodiments, the first question is distinguished from the second question based on at least one of the following manners: predetermined character identification, key information identification, and intention identification.

If a predetermined character is used for distinguishing, the object is prompted to input the predetermined character in the question when asking questions about the document content. Further, when the questions are distinguished, if the predetermined character (for example, “/”) is identified in the question, the question may be used as the first question, or if the predetermined character cannot be identified, the question may be used as the second question.

For another example, key information (a keyword, a keyword, or the like) identification is performed on the question. For example, a keyword “this document” is set, and if the keyword is identified in the question, the question may be used as the first question, or if the keyword cannot be identified, the question may be used as the second question.

In some embodiments, intention identification is performed on the question, an intention of the question is identified, and whether the intention is related to the previous first document is analyzed. If the intention is related to the previous first document, the question is used as the first question, or if the intention is not related to the previous first document, the question is used as the second question.

In addition, the several manners listed above may be combined. For example, questions may be distinguished by combining the predetermined character or keyword identification and the intention identification.

The foregoing process of distinguishing the questions may be performed by a server, that is, the client transmits the questions to the server, and the server performs distinguishing using the foregoing logic and feeds back a distinguishing result to the client.

In the foregoing implementation, when the object asks questions about both document content and non-document content, questions and answer messages are effectively distinguished by using message styles, to ensure that the object clearly knows which answer messages correspond to which questions, and clarifies a current asking scenario, and enhance object experience.

The foregoing uses an example in which the object uploads one first document, performs digest extraction on the first document, and performs question-answer, modification, and the like on a document digest of the first document. In addition, the object may upload multiple first documents, perform digest extraction on the multiple documents, and also perform question-answer, modification, and the like on document digests of the multiple documents.

When the object uploads multiple first documents at a time, digest extraction may be performed on the multiple first documents, to generate a document digest corresponding to each first document, or generate a document digest corresponding to an entirety of the multiple first documents.

To be specific, when there are multiple first documents, each first document may be presented in the information exchange interface, and processing information of the first document is presented in a status area corresponding to each first document. A specific presentation manner is the same as the foregoing listed presentation manner in the status area corresponding to the single first document, and also includes a collapsed form, an expanded form, and the like. This is not limited herein. Similarly, after content extraction on each first document is completed, display of the status area corresponding to the first document may be canceled.

In some embodiments, the multiple first documents may be processed in parallel, to ensure digest extraction efficiency and reduce a waiting time of the object. The document digest is presented in the following, but not limited to, two presentation manners:

Presentation manner 1: The first documents and document digests respectively corresponding to the first documents are separately presented in the information exchange interface, each first document and the document digest corresponding to the first document being a group of messages.

The manner indicates that each time one first document is processed, a document digest corresponding to the first document may be presented in the information exchange interface.

The first document in some embodiments may be in multiple presentation styles such as an actual document, a document icon, a document name, and a document link. This is not limited herein.

In some embodiments, when each first document and the document digest corresponding to the first document are presented by using a group of messages, the group of messages essentially includes at least one message, that is, may be one message, or may be multiple messages, and therefore actually has multiple corresponding presentation styles, which includes, but is not limited to, some or all of the following:
Presentation style 1: Each first document and a document digest of the first document are displayed in blocks in one message.
Presentation style 2: Multiple messages are displayed, and each message displays one first document and a document digest of the first document.
Presentation style 3: Multiple messages are displayed, and these messages are classified into two categories. A first category is that each message displays one first document, and a second category is that one each message displays one document digest.
Presentation style 4: One message is displayed, the message includes a document name of each first document and a document digest of each first document displayed in a segmented manner, and the document name and the document digest of the same first document may be displayed in the same paragraph.

The several presentation styles listed above are merely simple examples. A manner of presenting each first document and a respective corresponding document digest by using at least one message is applicable. Details are not described herein again.

The presentation style 3 is used as an example for description below.

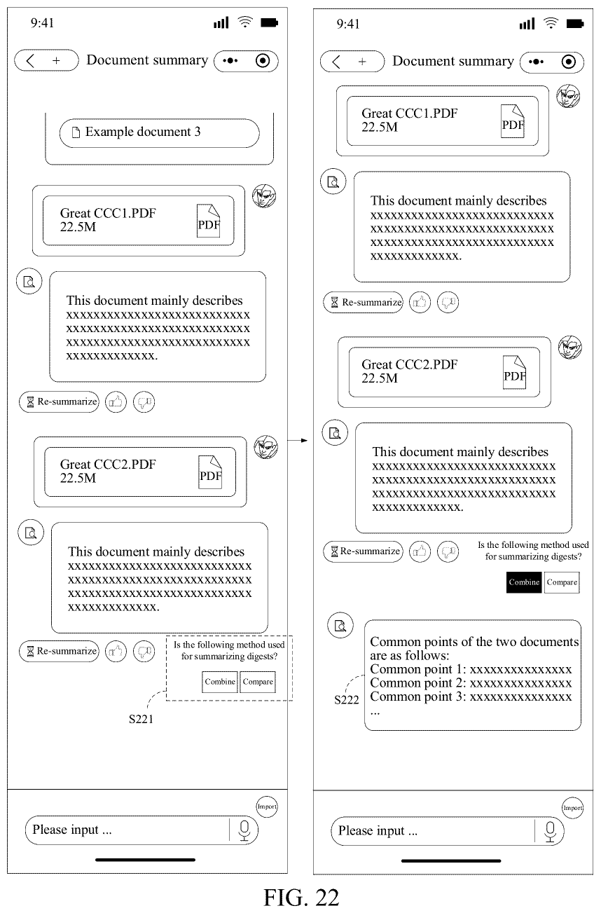

FIG. 22 is a schematic diagram of a presentation manner of multiple first documents and document digests according to some embodiments. If an object uploads two first documents at the same time, which are respectively a “Great CCC1” and a “Great CCC2”, the two first documents may be processed in parallel, to ensure as much as possible that a document digest corresponding to each first document is synchronously presented.

In some embodiments, when the document digest corresponding to each first document is presented, an interface shown in a left side of FIG. 22 is presented by using each first document and the document digest of the first document as a group of messages. For each first document, a re-summarization control, a feedback control, and the like may also be presented at related locations of the first document. A specific implementation is the same as that in the foregoing embodiment, and details are not described herein again.

In addition, in some embodiments, the object may autonomously select whether to summarize document digests of multiple first documents. An exemplary implementation is as follows:
In addition to separately presenting, in the information exchange interface, the first documents and the document digests respectively corresponding to the first documents, summarization prompt information is further presented.

The summarization prompt information is used to prompt whether to perform summarization processing on the document digests respectively corresponding to the first documents. A presentation time of the summarization prompt information is not limited herein. For example, the summarization prompt information may be presented when the document digests are presented in the information exchange interface, or the summarization prompt information may be presented after the object triggers a preset operation (such as a target gesture or a voice instruction) in the information exchange interface.

In some embodiments, the summarization processing includes at least one of the following: combining the document digests, determining a common point for the document digests, or determining a difference point for the document digests. Based on this, corresponding summarization prompt information may also have multiple forms. For example, the object is prompted to determine only a common point for multiple document digests; the object is prompted to determine only a different point for multiple document digests; the object is queried whether to determine a common point for multiple document digests or determine a different point for the multiple document digests; the object may be directly queried whether to summarize multiple document digests; or the like.

Further, when the object triggers the summarization processing, the client presents, in response to the summarization processing triggered for the summarization prompt information, the summarized document digest that is generated based on the document digests respectively corresponding to the first documents and that corresponds to the summarization processing.

FIG. 22 is still used as an example. A part S221 in FIG. 22 is an example of the summarization prompt information in some embodiments. The summarization prompt information includes text “1 s the following method used for summarizing digests?” and controls “combine” and “compare”. The combine control supports determining a common point for multiple document digests, and the compare control supports determining a difference point for the multiple document digests. If the object selects to combine, a summarized document digest shown in S222 may be presented. The summarized document digest is obtained after a common point for the previously generated document digests respectively corresponding to the two first documents is determined. Similarly, if the object selects to compare, a difference point for the previously generated document digests respectively corresponding to the two first documents is determined, to generate a summarized document digest.

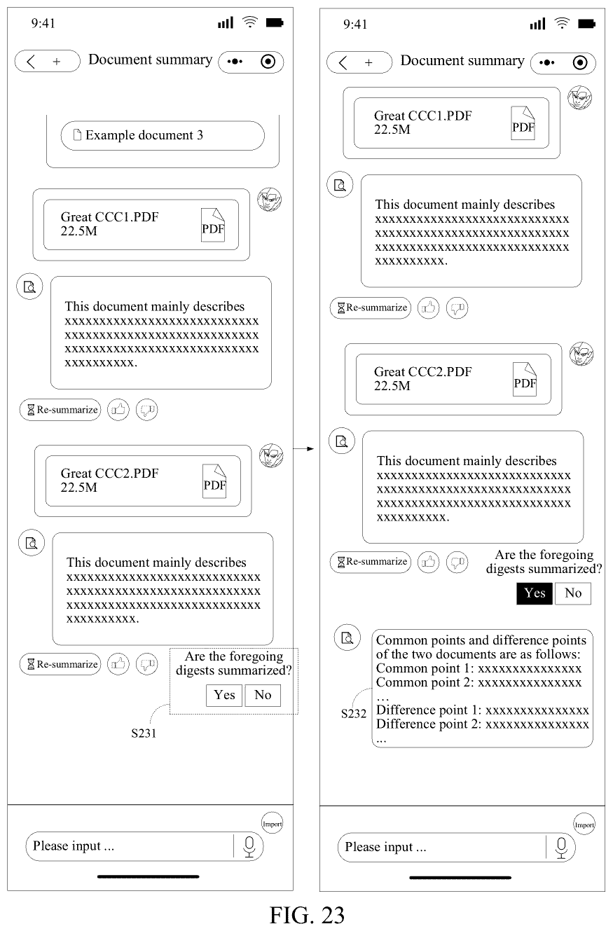

FIG. 23 is a schematic diagram of another presentation manner of multiple first documents and document digests according to some embodiments. Different from FIG. 22, summarization prompt information in FIG. 23 is in another style. As shown in S231, the summarization prompt information includes text “Are the foregoing digests summarized?” and controls “yes” and “no”. To be specific, there is no need to query the object whether to combine or compare multiple document digests, but the object is directly queried whether to summarize the document digests. If the object selects “yes”, a summarized document digest shown in S232 may be presented, and both a difference point and a common point for the previously generated document digests respectively corresponding to the two first documents, are determined, to generate the summarized document digest.

The summarization prompt information listed in FIG. 22 or FIG. 23 is merely a simple example, and summarization prompt information in another style is also applicable. Details are not described herein.

In addition, if the object uploads three or more first documents simultaneously, the object is further supported to autonomously select document digests that the object wants to summarize. If the object does not perform selection, document digests of multiple first documents simultaneously uploaded by the object this time are summarized by default.

Presentation manner 2: The first documents and a summarized document digest are separately presented in the information exchange interface, the summarized document digest being obtained by performing summarization processing on multiple document digests after the document digests respectively corresponding to the first documents are separately extracted.

In some embodiments, a group of messages is presented in the information exchange interface. The group of messages includes multiple first documents and a summarized document digest.

In some embodiments, the foregoing presentation manner 1 refers to presenting an independent digest of each first document, and in the manner in FIG. 22 or FIG. 23, the object is queried whether to summarize digests of multiple documents.

A difference from the foregoing presentation manner 1 is that, the presentation manner 2 means that there is no query, and an independent digest of each first document is not separately presented, but a summarized digest of multiple documents is directly presented.

In some embodiments, when the multiple first documents and the summarized document digest are presented by using a group of messages, the group of messages essentially includes at least one message, that is, may be one message, or may be multiple messages. In some embodiments, the multiple first documents and the summarized digests may be presented by using one message, or may be presented by using multiple messages, where these messages are classified into two categories. A first category is that each message displays one first document, and a second category is that there is only one message, used for displaying a summarized document digest; and the like.

The several presentation styles listed above are merely simple examples. Any manner of presenting each first document and a summarized document digest by using at least one message is applicable. Details are not described herein again.

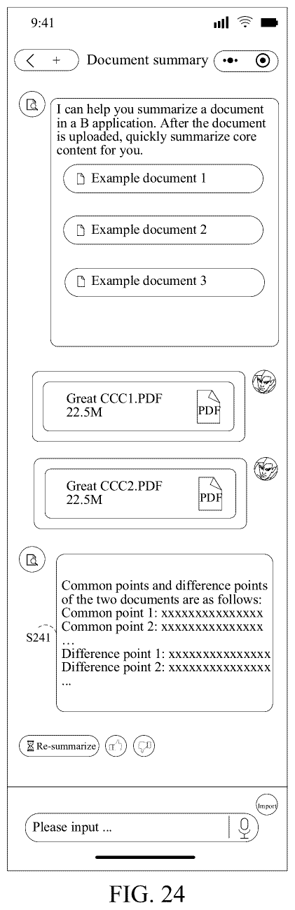

FIG. 24 is a schematic diagram of still another presentation manner of multiple first documents and document digests according to some embodiments. If the object uploads two first documents at the same time, which are respectively “Great CCC1” and “Great CCC2”, a document digest corresponding to each first document may not be separately presented, but a summarized document digest is directly presented, as shown in S241 in FIG. 24.

The foregoing listed related processing manners for the status area, the document digest, and the like when content extraction is performed on a single first document in some embodiments are also applicable to content extraction on multiple document digests. Details are not described herein again.

In the foregoing implementation, digest extraction is supported on multiple documents simultaneously, and the object is supported to select, according to a requirement of the object, whether to combine multiple document digests, so that the object learns of the multiple documents in time. In addition, when multiple documents are associated documents, multiple document digests are combined or compared, so that the object can learn of association between the multiple documents more conveniently, and learn of information such as respective focuses of the documents, thereby further improving document reading efficiency.

In addition, in a processing procedure of the first document, if the object wants to pause current content extraction, or leaves the current information exchange interface, the object may interrupt the current content extraction process.

An exemplary implementation is as follows: The client presents stop prompt information and a corresponding re-summarization control in the information exchange interface in response to a processing stop operation on the first document. The object may re-trigger a content extraction process for the first document based on the re-summarization control. The client re-performs content extraction on the first document in response to a trigger operation for the re-summarization control, and after the content extraction is re-completed, presents, in the information exchange interface, a document digest obtained by performing content extraction on the first document.

In addition, in the process of re-performing content extraction on the first document, a status area may also be presented, a current processing stage and a corresponding processing status are presented in the status area, and the object may also expand the status area to view a more specific processing procedure, or view a processing result corresponding to a processing stage in a target processing status, and the like. Details are not described again.

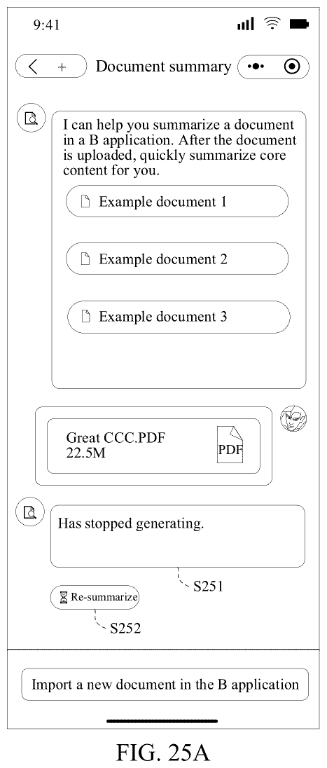

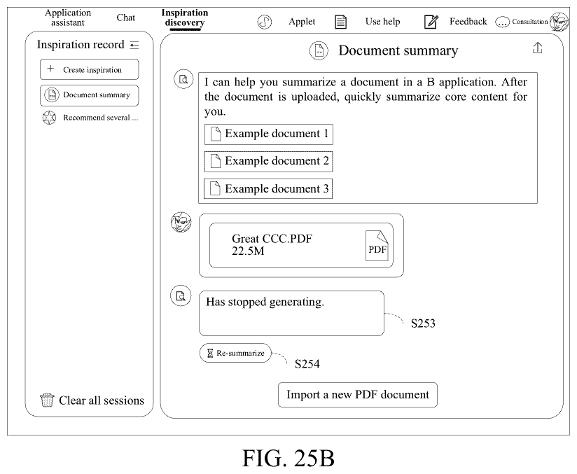

FIG. 25A is a schematic diagram of stop prompt information according to some embodiments. As shown in S251 in FIG. 25A, the stop prompt information indicates that generation of the document digest of the first document is stopped, and presentation of the stop prompt information may be triggered in the following manner:

As shown in a part S162 shown in FIG. 16, when the document digest is not completely outputted, the foregoing “Summarizing. Click/Tap to cancel” is updated to “Stop generating” shown in S162. The object may click/tap the control shown in S162, to pause outputting of the document digest, and stop prompt information shown in S251 is presented. Further, in a summarization process before the document digest is outputted, “Summarizing. Click/Tap to cancel” shown in S83 or S86 may be presented, or the control shown in S83 or S86 may be clicked/tapped by the object, to pause generation of the document digest, and stop prompt information shown in S251 is presented; and the like.

Similar to FIG. 25A, FIG. 25B is a schematic diagram of other stop prompt information according to some embodiments. As shown in S252 in FIG. 25B, the stop prompt information indicates that generation of the document digest of the first document is stopped.

When the stop prompt information is presented, a re-summarization control may be further presented. A presentation time of the re-summarization control is not limited herein. For example, the re-summarization control may be presented when the stop prompt information is presented in the information exchange interface, or the re-summarization control may be presented after the object triggers a preset operation (such as a target gesture or a voice instruction) in the information exchange interface.

S252 in FIG. 25A or S254 in FIG. 25B is an example of the re-summarization control listed in some embodiments. The object may click/tap the re-summarization control, to re-trigger a content extraction process for the first document. The client re-performs content extraction on the first document in response to a trigger operation for the re-summarization control, and after the content extraction is re-completed, presents, in the information exchange interface, a document digest obtained by performing content extraction on the first document.

In the foregoing implementation, the object is supported to be stopped at any time in the process of generating the document digest, or the document digest is quickly re-extracted via the re-summarization control, to provide higher operation flexibility for the object.

In addition, in the processing procedure of the first document, if the object wants to leave a current information exchange interface, the object may further be queried in a secondary confirmation prompt manner, to reduce occurrence of content extraction exiting this time due to a misoperation of the object. An exemplary implementation is as follows:
In the processing procedure of the first document, the client presents exit prompt information in response to an exit operation on the information exchange interface. The exit prompt information is configured for prompting an object of currently processing the first document, and query the object whether to confirm exit.

If the object confirms exit based on the exit prompt information, the information exchange interface is exited. If the object cancels exit based on the exit prompt information, processing of content extraction on the first document may continue.

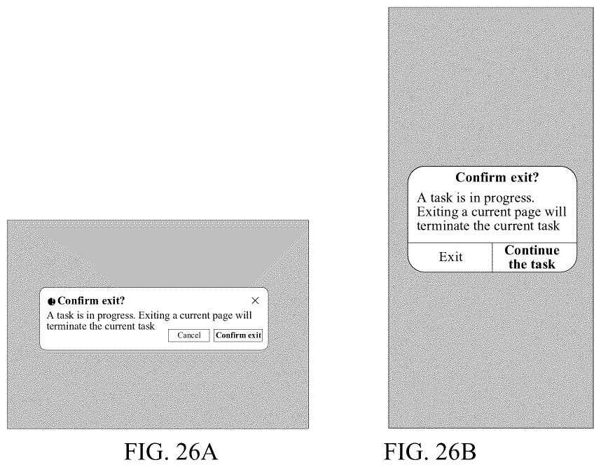

FIG. 26A is a schematic diagram of exit prompt information according to some embodiments, where exit prompt information includes text “Confirm exit? A task is in progress. Exiting a current page will terminate the current task”, and controls “cancel” and “confirm exit”. The object clicks/taps “confirm exit”, the current information exchange interface may be exited; and the object clicks/taps “cancel”, processing of content extraction on the first document may be continued.

In addition, if the object directly clicks/taps “x” in an upper right corner of a pop-up window shown in FIG. 26A, it may be considered that the object cancels current exit, and processing of content extraction on the first document is continued.

FIG. 26B is a schematic diagram of other exit prompt information according to some embodiments, where exit prompt information includes text “Confirm exit? A task is in progress. Exiting a current page will terminate the current task”, and controls “exit” and “continue the task”. An object clicks/taps “exit”, and a current information exchange interface may be exited; and the object clicks/taps “continue the task”, and processing of content extraction on a first document may be continued.

In the foregoing implementation, the object is supported to exit at any time in a process of generating a document digest, and a secondary confirmation prompt is used to prevent the object from terminating a digest extraction process due to an accidental touch.

After the document digest is normally generated, in some embodiments, in addition to allowing the object to perform multiple rounds of question-answer based on the document digest, the object may also share and forward the generated document digest.

An exemplary implementation is as follows:
The client presents at least one second function control corresponding to the document digest of the first document. These second function controls are operation controls for the document digest. The object may share and forward the document digest based on the second function control. In this case, the client transmits the document digest and the first document to a to-be-shared object in response to a sharing operation triggered based on the at least one second function control. Herein, the to-be-shared object is, for example, a user account.

In some embodiments, the document digest may be shared in a form such as a link, an applet, or a picture. For example, shared in a form of a link is supported on a personal computer (PC) side, and shared in a form of an applet is supported on a mobile side. This is not limited herein.

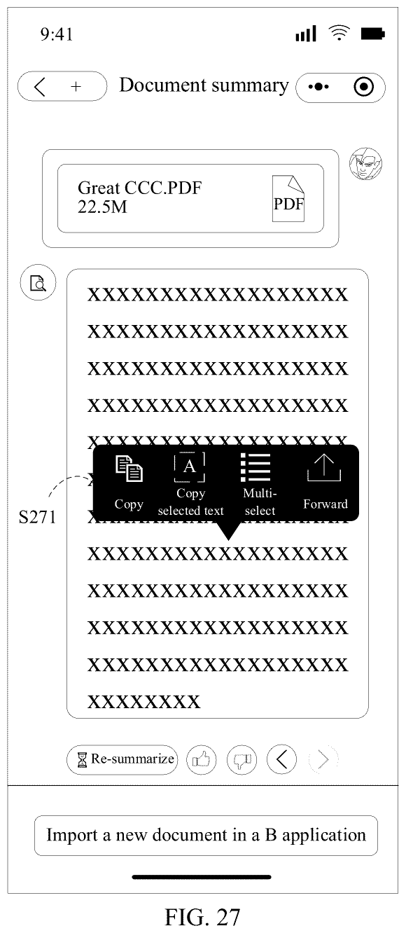

The second function control may be presented after the object performs a target action. FIG. 27 is a schematic diagram of a second function control according to some embodiments. In an example in which the target action is touch and hold, if the object touches and holds a document digest message box (also referred to as a bubble), four second function controls shown in S271 may be presented, which are respectively: copy, copy selected text, multi-select, and forward. The object may click/tap “forward” and select a to-be-shared object for forwarding. Then, the client transmits the document digest and the first document to the to-be-shared object in response to a sharing operation that is triggered based on the forward control.

In addition, the second function control may be presented when the document digest is presented. Still using FIG. 18B as an example, S187 is a copy control in some embodiments, and S188 is a forward control in some embodiments. The two controls are the second function controls corresponding to the document digest of the first document. The object may click/tap “forward” and select a to-be-shared object for forwarding. Then, the client transmits the document digest and the first document to the to-be-shared object in response to a sharing operation that is triggered based on the forward control.

The several second function controls listed above are merely simple examples, and any operation control related to the document digest may be used as the second function control, and details are not described again.

Moreover, the foregoing describes a process of sharing a current message. In addition, the object may select one or more messages for sharing from a current interface.

In some embodiments, when the object autonomously selects one or more messages, the object may select a message for direct sharing, or may select multiple messages for sharing by using a multi-select control after the object selects a message and the multi-select control is presented. In some embodiments, the object may click/tap a share control at an upper right corner (or at another location) of the current interface, select multiple messages for sharing after clicking/tapping the share control, and the like.

In the foregoing manner or another selection manner, the object may select to share multiple messages, and in addition to sharing the first document and the document digest, may further share multiple rounds of question-answer related to the first document, share another message, or the like.

In the foregoing implementation, the object may share and forward the document digest generated for the first document, to perform discussion and communication with another object.

In some embodiments, if the object is used as a recipient, for example, a link/applet or the like shared by another object for a shared document is received, the link/applet or the like may be clicked/tapped to present the shared document, a document digest corresponding to the shared document, and a new session entry. The object may perform a new information exchange interface based on the new session entry. The client presents a default message and a document upload control in the information exchange interface in response to a trigger operation for the new session entry, the default message being configured for presenting an example of a document summarization function, and the document summarization function indicating that a document digest is generated by performing content extraction on a document. The object may upload a new document based on the document upload control to perform content extraction. For a process of uploading the new document and performing content extraction on the new document, refer to the foregoing embodiment. Details are not described herein again.

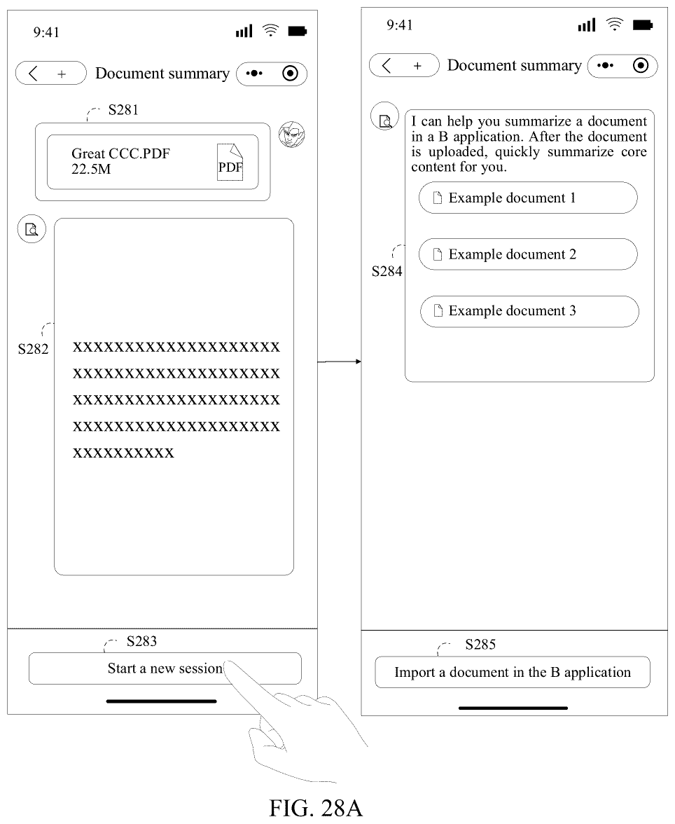

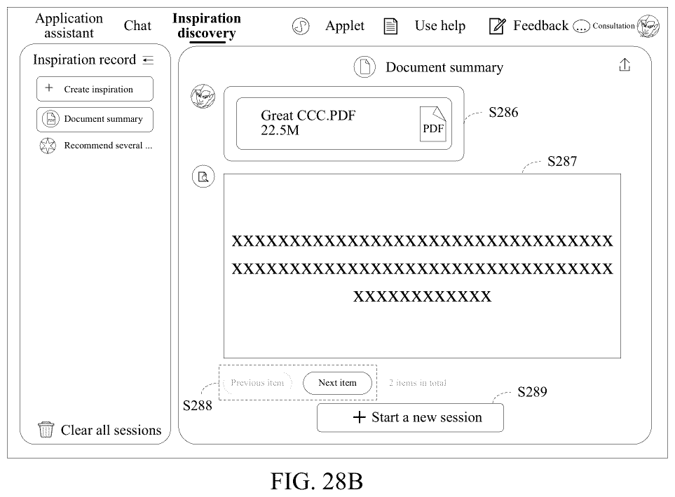

FIG. 28A is a schematic diagram of a landing page for a recipient according to some embodiments. As shown in FIG. 28A, S281 is a shared document, S282 is a document digest of the shared document, S283 is a new session entry in some embodiments, and an object may click/tap the new session entry to enter an interface shown on a right side of FIG. 28A. S284 is a default message, and S285 is a document upload control. The object may upload a new document based on the document upload control shown in S285 to perform content extraction.

FIG. 28B is a schematic diagram of another landing page for a recipient according to some embodiments. As shown in FIG. 28B, S286 is a shared document, S287 is a document digest of the shared document, S288 is a digest switching control of the document digest, and S289 is a new session entry in some embodiments. When a sharer generates digests multiple times on the shared document, the digest switching control shown in S288 may further be presented, to switch to a previous digest or a next digest, and the like.

In the foregoing implementation, an object is supported to share and forward the document digest, so that when another object also quickly learns of document content, a discussion degree between objects may further be increased.

The content extraction method in some embodiments further supports the object to view a historical record related to document content extraction. An exemplary implementation is as follows:

The client presents, in response to a viewing operation on a historical record of a target object, historical documents that correspond to the target object and whose document digests have been currently generated. When the historical documents are viewed, the object may view a corresponding document digest of any historical document. The client presents, in response to a viewing operation on any historical document in the historical documents, the document digest corresponding to the any historical document.

The target object may refer to an account that the client currently logs in to.

In some embodiments, the target object may be returned from the information exchange interface to a historical record interface, or the historical record interface is directly started, or the like. The historical documents that correspond to the target object and whose document digests have been currently generated and corresponding content extraction times are displayed in the historical record interface.

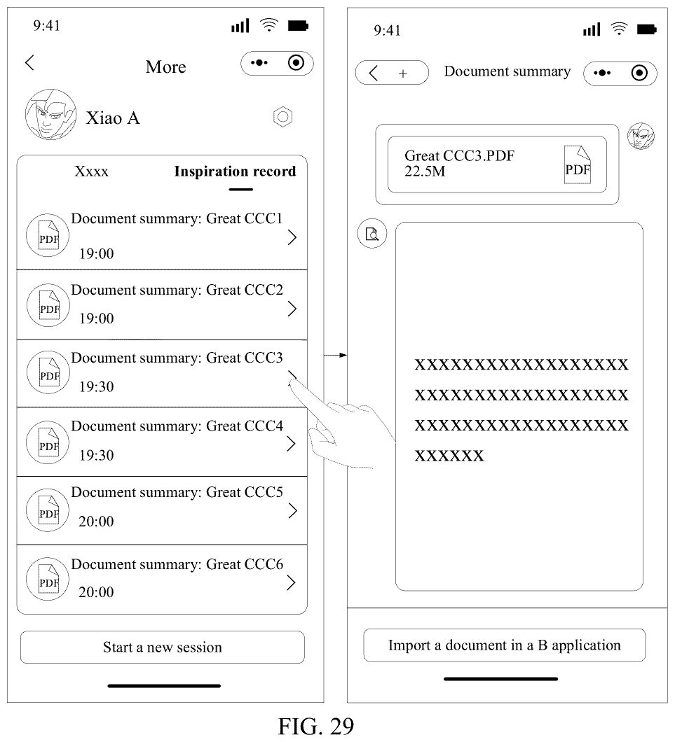

FIG. 29 is a schematic diagram of a historical record according to some embodiments. Historical documents that is of a target object “Xiao A” and whose document digests have been currently generated are displayed in the historical record interface, for example, Great CCC1, Great CCC2, Great CCC3, and the like in FIG. 29, and a content extraction time corresponding to each document. The target object may select one historical document. For example, the target object selects “Great CCC3”, and then an information exchange interface shown on a right side of FIG. 29 is presented, to view a document digest corresponding to the document. In addition, the object may further click/tap “start a new session” to enter an information exchange interface including a default message and a document upload control, and the like.

In the foregoing implementation, the object is supported to view the historical record, and conveniently learns of the generated document digest of each historical document in time.

In a process of performing content extraction on the first document, or after the content extraction is completed, or in a sharing state, or the like, the first document shown in the information exchange interface may be clicked/tapped, to download the first document.

In addition, the content extraction method in some embodiments is briefly described mainly from a client side. The content extraction method in some embodiments is further described below from a server side:

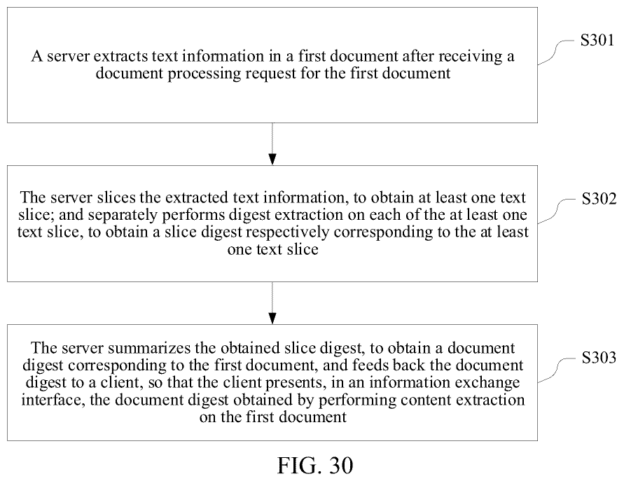

FIG. 30 is an implementation flowchart of another content extraction method according to some embodiments. Taking a server as an execution subject as an example, a specific implementation procedure of the method includes the following S301 to S303:
S301: A server extracts text information in a first document after receiving a document processing request for the first document.

The first document is uploaded by a client in response to a selection operation on the first document in at least one document in a document selection interface, and the document selection interface is presented by the client in response to an uploading operation that is triggered based on an information exchange interface.

In conclusion, the content extraction method in some embodiments supports uploading of a single document/multiple documents. A single document is used as an example. Document content needs to be sliced, and content extraction is performed on each piece of slice content, to further determine a digest of the entire document. To implement the function, first, the document needs to be parsed, all text information in the document is extracted, then divided into slices, content extraction is performed on each slice, to obtain a slice digest, and finally, content extraction is performed again on multiple slice digests as a whole, to obtain a document digest corresponding to the entire document. For multiple documents, these document digests may be further summarized based on obtaining a respective document digest of a single document.

In some embodiments, the object may select at least one first document based on a document selection interface in the client and upload the at least one first document to the server. The document processing request may be sent by the client to the server in response to an uploading operation performed by the object on the first document.

After receiving the document processing request for the first document, the server first needs to parse the document, and extracts all text information (also referred to as literal information) in the document. In some embodiments, document parsing refers to parsing document content, to obtain text in the document, including text, text extracted from a picture (which may be obtained through OCR), subtitles and text of a video, and text obtained by converting spoken words in a video speech (which may be obtained through automatic speech recognition (ASR)), and then organize various types of text according to a spatial sequence. Then, the following operations S302 and S303 may be performed.

S302: The server slices the extracted text information, to obtain at least one text slice; performs digest extraction on each of the at least one text slice, to obtain a slice digest respectively corresponding to the at least one text slice.

A paragraph may be used as a slice granularity during document slicing, or a fixed text length L may be set. A value of L is a positive integer, and may be determined according to an actual requirement.

For example, if a fixed text length L=3000 is set, in some embodiments, the document slicing means that the text obtained in the document parsing section is sliced into text segments whose lengths do not exceed L (L=3000) tokens, and are also referred to as text slicing.

A specific slicing method is: starting from a start token, selecting L tokens each time. When a complete sentence is sliced, a punctuation mark such as the last full stop, the last question mark, or the last exclamation mark is found forward for slicing, or a punctuation mark such as the first full stop, the first question mark, or the first exclamation mark is found backward for slicing.

In other words, lengths of finally obtained text slices are not necessarily all L, but slicing is performed with reference to the length of L. To ensure completeness of a sentence as much as possible without affecting semantics of the sentence, when a complete sentence needs to be sliced, a text slice whose length is around L may be considered to be generated with reference to the punctuation mark.

In the foregoing slicing manner, it can be ensured as much as possible that original semantics of the sentence are not affected, to improve accuracy of subsequent content extraction.

In some embodiments, when at least one text slice is obtained, digest extraction may be separately performed on each obtained text slice through content extraction, to obtain main content (that is, a slice digest) of each text slice. An exemplary implementation is as follows:
The at least one text slice is separately inputted into a content extraction model, and a slice digest corresponding to the text slice extracted for each text slice by using the content extraction model according to a preconfigured first digest instruction, the first digest instruction being configured for determining a word count and a summary format of the slice digest.

The content extraction model may be used for performing digest extraction on text content (which is the text slice herein), and may also be understood as summarizing content of the text slice, and summarizing the main content as the slice digest. Therefore, target text processing may be any text processing model having a digest extraction function. For example, the content extraction model is a text processing model such as an LLM.

For example, when digest extraction is performed on the text slice by using the foregoing model, an extraction method is adding, to prompt information, a first digest instruction that requires the content extraction model to perform content digest extraction, and determining a word count and a summary format of the slice digest. The summary format is, for example, “summarize the text slice as concisely and clearly as possible, without exceeding XXXX words, and cover important information of the text slice”. The content extraction model performs digest extraction on each text slice according to such an instruction, and returns a slice digest corresponding to each text slice.

In the foregoing implementation, by preconfiguring the first digest instruction, the slice digest meeting a requirement related to the digest instruction may be outputted by using a large model, to facilitate subsequent digest summarization.

S303: The server summarizes the obtained slice digest, to obtain a document digest corresponding to the first document, and feeds back the document digest to the client, so that the client presents, in the information exchange interface, the document digest obtained by performing content extraction on the first document. Herein, summarizing the obtained slice digests is summarizing content of multiple slice digests as a whole.

In conclusion, in some embodiments, the slice digests of the slices are first determined, and then the content of the multiple slice digests is summarized as a whole, so that accuracy of the document digest can be improved.

In some embodiments, after the slice digest of each text slice is obtained, all obtained slice digests may be summarized together, and then summarization is performed by using the content extraction model, to obtain an overall digest corresponding to the first document, that is, the document digest in some embodiments. An exemplary implementation is as follows:
Each slice digest is separately inputted to the content extraction model, and each slice digest is summarized by using the content extraction model according to a preconfigured second digest instruction, to generate a document digest, the second digest instruction being configured for determining a word count and a summary format of the document digest.

The content extraction model may further be used for summarizing (that is, performing content extraction on) text content (summarized content of slice digests), and may be any text processing model having a digest summarization function.

For example, when content extraction is performed on the slice digest of each text slice by using the foregoing model, a content extraction method is adding, to prompt information, a second digest instruction that requires a main model (that is, the content extraction model) to perform content digest summarization, and determining a word count and a summary format of the document digest, for example, “summarize the foregoing content, it is not required to exceed 300 words, a central idea of an article needs to be included, and important information of three to five articles is listed”. The main model summarizes the summarized content of the slice digests again according to such an instruction, and returns a document digest corresponding to the overall first document.

In the foregoing implementation, by preconfiguring the second digest instruction, the document digest meeting a requirement related to the digest instruction may be outputted by using a large model, to effectively summarize overall content of the first document.

The main model in some embodiments may be used for extracting main content and a topic of text, summarizing the text, and the like, belongs to a natural language processing model, and may be any text processing model having the foregoing function, for example, an LLM or another model. This is not limited herein.

Further, in some embodiments, it is considered that because content of each text slice of an article is usually relatively long, and a large language model above 6B needs to be used to perform slice digestion. Therefore, in some embodiments, an LLAMA 13B large model is specially trained to perform digest extraction.

In some embodiments, when there are multiple first documents, in addition to summarizing a document digest corresponding to each first document in the foregoing manner, a respective topic of each first document further needs to be summarized. Document digests corresponding to the first documents are summarized based on respective topics of the first documents, and then, a summarized document digest may be obtained and fed back to the client, so that the client presents the summarized document digest in a form of a message in the information exchange interface, as shown in FIG. 22, FIG. 23, or FIG. 24.

In conclusion, some embodiments support the object to upload multiple documents at a time, separately summarizes content of the multiple documents, and summarizes document content. A process of performing content extraction on the multiple documents is described in detail below:

In some embodiments, to implement the capability, each document needs to be interpreted and summarized from multiple perspectives, and then information from the multiple perspectives is summarized, to perform summarization and/or comparison. Specific implementation details are as follows:

First, multiple documents are parsed. Similar to the parsing process of a single document listed above, parsing of the multiple documents is parsing content of each document, to obtain text in the document, including text, text extracted from a picture, subtitles and text of a video, and text obtained by converting spoken words in a video speech, and then organize various types of text according to a spatial sequence. Herein, finally obtained text information corresponding to the first document is denoted as:

$$T = [ \begin{matrix}{text}_{1} \\ {text}_{2} \\ … \\ {OCR}_{1} \\ {OCR}_{2} \\ … \\ {ASR}_{1} \\ …\end{matrix} ]$$

T corresponds to one first document, and parsed text information corresponding to each first document may be recorded as one T, including extracted text (text1 and text2), . . . , text (OCR1 and OCR2) obtained through picture identification, . . . , text (ASR1) obtained through speech identification, . . . .

After each first document is separately parsed, and text information corresponding to each text is extracted, each document may be digested and summarized, and a long document is sorted into a rough digest of M words (for example, M=500), that is, a document digest (which may be understood as a rough digest) corresponding to each first document is extracted. M is a positive integer, and a value of M may be flexibly set according to an actual requirement, for example, 500, 300, and 200. This is not limited herein.

After the first document is parsed, a process of extracting the rough digest of the document may be summarized into several parts: document slicing, slice digest extraction, summarization of digests, and content integration.

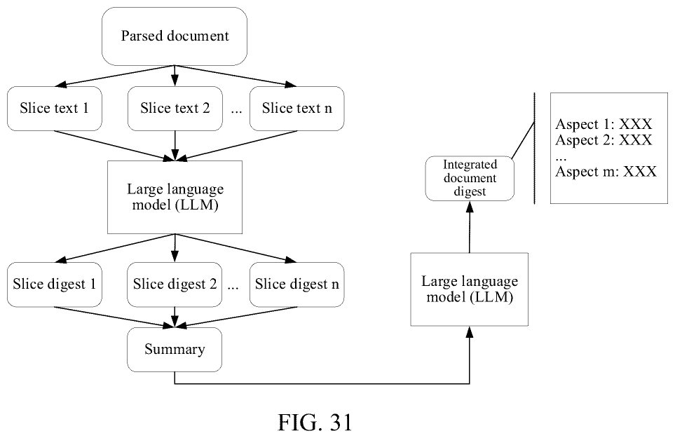

For processes of document slicing, slice digest extraction, and summarization of digests, refer to the foregoing embodiment. The following briefly provides description with reference to FIG. 31.

FIG. 31 is a schematic diagram of a process of extracting a rough digest of a single document according to some embodiments. As shown in FIG. 31, after a parsed document is sliced based on L, to obtain n slice texts, slice digest extraction may be separately performed on the n slice texts based on a large language model (LLM), to obtain n slice digests. Then, all the slice digests are summarized together, and then summarization is performed by using the large language model (LLM), to obtain an integrated document digest, that is, a rough document digest corresponding to an entire article.

In addition, in the operation of summarization of digests, specific aspects of topics of the article further need to be summarized, so that subsequently, in the operation of content integration, document digests of multiple single documents are summarized, to obtain a summarized document digest corresponding to the overall multiple documents.

In some embodiments, content integration refers to combining results obtained in the operation of summarization of digests, and performing expanded description according to topics summarized in the operation of summarization of digests, to implement summarization of multiple documents. To implement the capability, each article needs to be interpreted and summarized from multiple perspectives, and then information from the multiple perspectives is summarized.

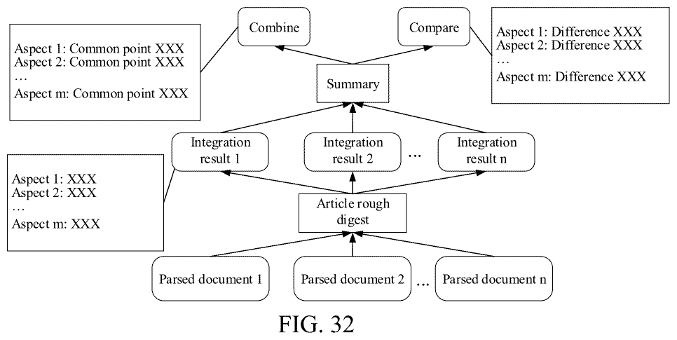

FIG. 32 is a schematic diagram of a process of extracting a summarized digest of multiple documents according to some embodiments. For example, article rough digests are respectively extracted from multiple parsed documents. For example, in FIG. 32, a rough digest corresponding to a parsed document 1 is an integration result 1, a rough digest corresponding to a parsed document 2 is an integration result 2, . . . , and a rough digest corresponding to a parsed document n is an integration result n. Each integration result is obtained by interpreting and summarizing a document from multiple perspectives, as shown in FIG. 32 by using m aspects as an example.

After the rough digest of each document is extracted, the n integration results may be summarized according to topics integrated in rough classification, and are classified into combination and comparison, to generate a common point and a difference (that is, a difference point) in each aspect.

In the foregoing implementation, the object may support uploading a document (a document format is not limited) on a front end. After the uploading, various parsing services are called to perform document parsing, and after the parsing, slicing is performed in a smart slicing manner. A slice digest is summarized for content of each slice, and then the slice digest is summarized into an overall article digest for output by using a model. Through experimental analysis, the content extraction method in some embodiments has significant effects in aspects such as correctness, completeness, concision, intuitiveness, and coherence of the generated document digest.

In addition, the foregoing is a simple description of the process of digest extraction on a single document or multiple documents. It can be learned from the foregoing that, the process of performing digest extraction on each document includes multiple processing stages, such as uploading a document, extracting content information, processing picture content, processing text content, extracting a core idea, and sorting and combining digests listed above. Processing statuses corresponding to these processing stages also need to be fed back to the client in time, and the client presents the processing statuses to the object in the status area. An exemplary implementation is as follows:

Processing information of the first document is fed back to the client in real time, so that the client presents the processing information in the status area (in a collapsed form) corresponding to the first document, such as S71 in FIG. 7A; or presents each processing stage existing when content extraction is performed on the first document and a respective processing status of each processing stage in the status area (in an expanded form), such as S91 in FIG. 9A.

The processing information indicates a current processing stage existing when content extraction is performed on the first document and a corresponding processing status. For details, refer to the foregoing embodiment. Details are not described herein again.

In addition, subsequently, when the object views a processing result corresponding to a target processing stage by using the client, the client may also transmit a corresponding request to the server, and the server feeds back the processing result to the client and presents the processing result to the object, for example, as shown in FIG. 14 or FIG. 15.

In addition, the server may further estimate an estimated completion time corresponding to each processing stage for the first document. The time may be predicted according to a data volume of content that needs to be processed, content complexity, model performance required for processing the content, and the like, to further feed back, in real time, an estimated completion time corresponding to a key processing stage to the client, so that the client presents, in the status area, countdown information of the estimated completion time corresponding to the key processing stage when the current processing stage of the first document is the key processing stage, for example, as shown in S101 in FIG. 10A, S102 in FIG. 10B, and FIG. 11.

Some embodiments further support the object to ask a question about the document digest. As shown in FIG. 19A, FIG. 19B, and the like, the object may input, on a client side, a first question for a document digest corresponding to the first document. Further, the client transmits the first question to the server. After obtaining the first question inputted by the object for the document digest, the server rewrites the first question with reference to a second question inputted before the first question and a corresponding answer message, to obtain a modified first question. Further, the server extracts first feature information corresponding to the modified first question, and obtains second feature information corresponding to each content slice in the first document; and finally matches the first feature information with each piece of second feature information separately, and generates, according to a matching result, an answer message corresponding to the first question.

The second feature information corresponding to each content slice in the first document may be prestored on a server side. Each content slice is obtained by dividing the first document based on a preset slice granularity. The preset slice granularity may be flexibly set according to an actual requirement. For example, the preset slice granularity may be a paragraph, a sentence, or the like. This is not limited herein.

In conclusion, in the single-document and multi-document scenarios, some embodiments support answering, according to content of a document, a subsequently-posed question from the second round of session.

To implement the capability, on one hand, a question needs to be rewritten with reference to a context, and on the other hand, more fine-grained paragraph division or even sentence-level division needs to be performed on a document.

The following describes the related process of question-answer by using an example in which the preset slice granularity is a sentence:
First, a round or multiple rounds of rewriting are performed with reference to the question and the previous answer in the context, and an original meaning of question-answer content is maintained. Finally, a rewritten question is obtained. For example, the object first asks “How to make scrambled eggs with tomatoes?” and then (in this question-answer) asks “How should soy sauce be added in this dish?”, in this question-answer process, the second question needs to be rewritten with reference to the previous (that is, the first) asked question, an answer message, and the like. For example, the rewritten question is “How should soy sauce be added when making scrambled eggs with tomatoes?”

After the modified question (that is, the modified first question) is obtained, feature extraction is performed on the rewritten question to obtain first feature information.

Furthermore, it is also necessary to perform feature extraction on the first document to be queried. For example, feature extraction is performed on document content at the granularity of the sentence, and correlation between sentences are also modeled to obtain and store second feature information corresponding to each sentence (content slice).

Then, the document content is retrieved with reference to the first feature information and the second feature information, to find document content related to the question. In this operation, in some embodiments, a similarity between the first feature information and each second feature information may be separately calculated. For example, a similarity is represented by a distance between vectors, and a sentence corresponding to second feature information with a similarity higher than a specific threshold is used as the document content related to the question.

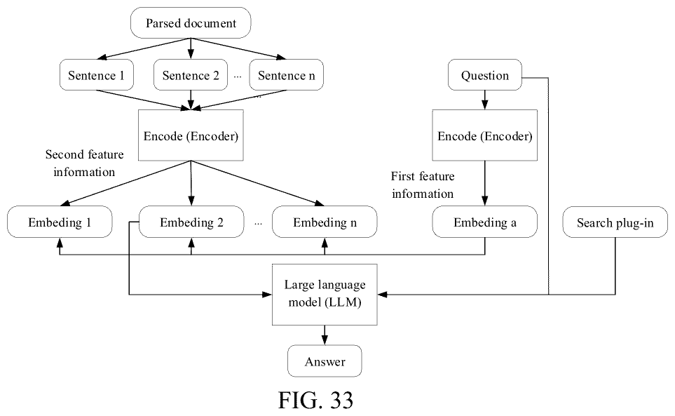

FIG. 33 is a schematic diagram of a feature matching process according to some embodiments. A parsed document may be divided into multiple content slices at a granularity of a sentence, such as sentence 1, sentence 2, . . . , sentence n in FIG. 33. Second feature information corresponding to each sentence may be extracted through encoding (Encoder), that is, a sentence-level embedding vector for each sentence in the document, such as embedding 1, embedding 2, . . . , embedding n in FIG. 33, is extracted. These embeddings may be stored on a server side, and directly queried during subsequent question-answer and the like.

In addition, after the question is rewritten in the context, first feature information corresponding to the rewritten question may be extracted through encoding (Encoder), that is, a sentence-level embedding for a question asked in a session, such as embedding a in FIG. 33, is extracted.

Then, question retrieval is performed. According to the embedding obtained through feature extraction, the document embedding is retrieved to learn if there is similar content. In some embodiments, embedding a is matched with embedding 1, embedding 2, . . . , and embedding n separately. A distance between vectors is calculated. A closer distance between two vectors corresponds to a higher similarity. Further, a sentence corresponding to second feature information with a similarity higher than a specific threshold is used as the document content related to the question.

In some embodiments, retrieval includes the following three cases:
a. Content of an article has a related part, a question may be answered: answered directly according to related content.
b. Content of an article has a related part, but a question cannot be answered: start a search plug-in, and return a search result. In some embodiments, when a question feature is matched with a document feature, if question content is mentioned in the document, but there is no clear answer, the search plug-in is further supported for searching according to a clue mentioned in the document.
c. Content of an article has no related part, and a predetermined expression is returned, indicating that no answer is provided.

Finally, in the case a, an answer message corresponding to the first question may be generated by using the main model (that is, the content extraction model) according to a related question and retrieved document-related content, for answering. In the case b, an answer message may be generated after summarization by using the main model according to a search result, a question, and retrieved document-related content, for answering.

In addition, during feature extraction, structure information of the document is reserved, including information such as a page number and a chapter. In this way, during subsequent retrieval, a range of content slices that need to be searched may be first narrowed based on the information such as the page number and the chapter. Instead of searching content slices included in the entire document, a content slice included in the page number, the chapter, and the like related to the first question is searched. For example, a question specifies a specific page and/or specific chapter, a round of filtering on content slices is first performed based on information such as a chapter and a page number in the question, to narrow a range of content slices on which feature matching needs to be performed subsequently.

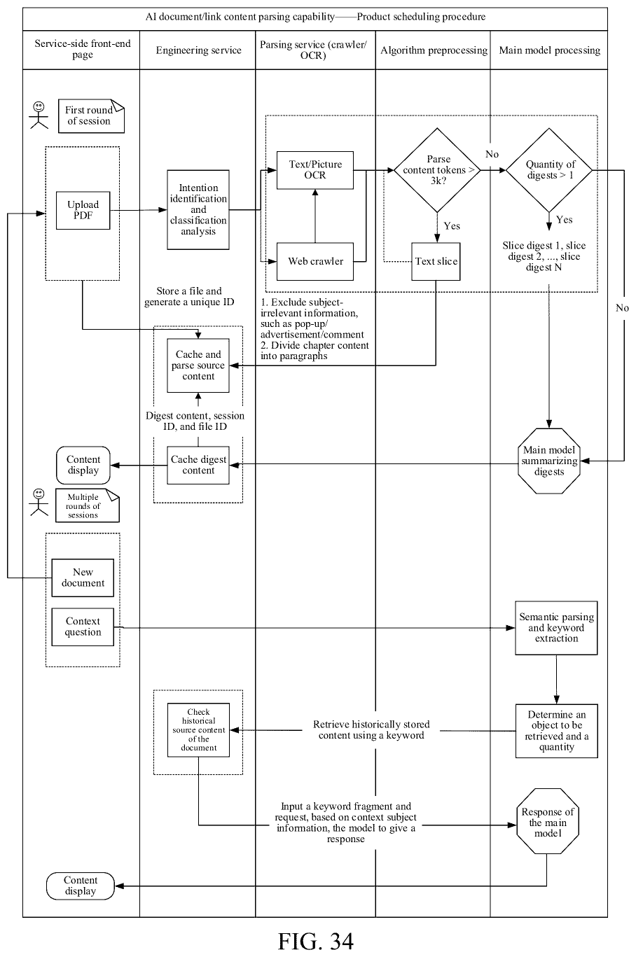

FIG. 34 is a schematic diagram of a document content parsing and question-answer scheduling procedure according to some embodiments. The procedure relates to several parts: a service-side front-end page, an engineering service, a parsing service (crawler/OCR), algorithm preprocessing, and main model processing (which may also be understood as a model service).

The service-side front-end page is mainly used for implementing interaction with an object, for example, in a first-round session process, the object uploads PDF (that is, a first document). Then, the engineering service performs processing such as intention identification, classification, and parsing on the PDF uploaded by the object. Then, the PDF is parsed by using the parsing service, which in some embodiments includes extracting text in the PDF, performing OCR identification on a picture, and processing such as a web crawler, to exclude subject-irrelevant information, such as pop-up/advertisement/comment, and divide chapter content in the PDF into paragraphs. Then, text slicing is performed on the PDF based on algorithm preprocessing. Referring to the foregoing embodiment, in an example in which L=3k (that is, 3000), whether content tokens are greater than 3k needs to be parsed, and if the content tokens are greater than 3k, text slicing is performed on text information included in a parsed document based on a specific implementation in the foregoing embodiment; or if the content tokens are not greater than 3k, operations related to main model processing are performed.

After at least one text slice is obtained based on algorithm preprocessing, each slice digest is generated by using main model processing, a document digest corresponding to the overall first document is generated, after summarization, and is returned to the service-side front-end for content presentation. For a specific implementation, refer to the foregoing embodiment. Details are not described herein again.

In a processing procedure of the main model, quantities of extracted digests vary with different quantities of text slices obtained in the previous operation because in the process, whether a quantity of digests is greater than 1 needs to be further determined, and if the quantity of digests is greater than 1, slice digests (for example, a slice digest 1, a slice digest 2, . . . , and a slice digest N in FIG. 34) are further summarized based on the main model, to obtain a document digest corresponding to the first document. If the quantity of digests is not greater than 1, the document digest corresponding to the first document is directly extracted based on the main model.

Content extraction is performed on the first document based on the main model to obtain the document digest, and the document digest is transmitted to the engineering service for caching digest content, and is bound to previous cached and parsed source content with reference to the digest content, a session ID, and a file ID. In addition, content may be presented by using a service-side front-end page, and the document digest of the first document may be presented, for example, as shown in S161 and S163 in FIG. 16. For a specific implementation, refer to the foregoing embodiment. Details are not described herein again.

In a multi-round session scenario, the object may upload a new document, may ask a question about the document digest of the first document, or the like. When the object performs extraction on the first document, the question is rewritten with reference to a context, semantic parsing and keyword extraction are performed on the rewritten question, and then an object to be retrieved and a quantity are determined based on the foregoing result. For example, descriptions related to a chapter and a page number are determined after keyword extraction is performed on the rewritten question, and then the object (which refers to the content slice) that needs to be retrieved and the corresponding quantity may be determined based on this. Then, historically stored content is retrieved with reference to a keyword, and historical source content of the document (that is, content related to the question in the first document) is retrieved based on a matching result between the previously stored content slice of the first document with corresponding second feature information and first feature information corresponding to the rewritten question. Finally, a keyword fragment is inputted in the main model, the model is requested based on context subject information to give a response, and after an answer message corresponding to the question is obtained by using the main model, the answer message is returned to the service-side front-end page for content presentation, as shown in FIG. 19A and FIG. 19B. For a specific implementation, refer to the foregoing embodiment. Details are not described herein again.

In conclusion, in some embodiments, text feature storage is performed on the document parsing result, to support multiple rounds of question-answer. When the object inputs multiple rounds of question-answer, a system performs similarity matching on a question of an object and a text feature of a document parsing result to find content in the document that is most related to the question of the object; and then performs summarization by using a model to output an answer. This method can implement multiple rounds of question-answer, and has good performance in effect.

In some embodiments, in S301, if the server receives multiple document processing requests within a period of time, the document processing requests maybe scheduled in the following manner, to perform content extraction on the multiple documents to generate corresponding document digests:

performing parallel processing on document processing requests whose receiving time differences are within a preset time range based on a receiving time corresponding to each of the multiple received document processing requests, to perform content extraction on the corresponding documents, and generate corresponding document digests.

The preset time range may be flexibly set according to an actual requirement, such as 1 minute, 30 s, or 10 s. This is not limited herein.

Compared with the related technology in which resources are often insufficient and a queuing time of an object is excessively long, the foregoing request scheduling manner provided in some embodiments greatly improves model resource utilization, and concurrency of the model can be increased by accessing a same model service for questions with similar times. In addition, it is ensured that when a new incoming question always accesses an available model resource when the available model resource is present, to avoid poor experience caused by blocking when the object accesses a resource being used for inference due to the question.

In some embodiments, the process of extracting each slice digest in S302 may be implemented by using parallel multiple models, that is, digest extraction is performed on at least one text slice in parallel, to obtain a slice digest respectively corresponding to the at least one text slice.

In some embodiments, in the process of performing content extraction on the first document, after the text information of the parsed document is sliced by using an algorithm into multiple text slices having a limited word count, model services are called in parallel to perform summarization, to obtain multiple summarized slice digests. Then, the multiple summarized slice digests are summarized, and a model service is called to obtain a final content digest, which is fed back to the object. In this manner, a time of the process of generating the content digest can be controlled to be in a short time.

In addition, some embodiments further support to resolve input review and output review without affecting performance, thereby ensuring output security.

In some embodiments, security review is performed in real time for document content, extracted digest content, the first question inputted by the object, the modification instruction, and the like. Once sensitive and/or harmful information appears, a current session may be recalled or terminated, to prevent the object from maliciously guiding the model to generate sensitive and harmful information.

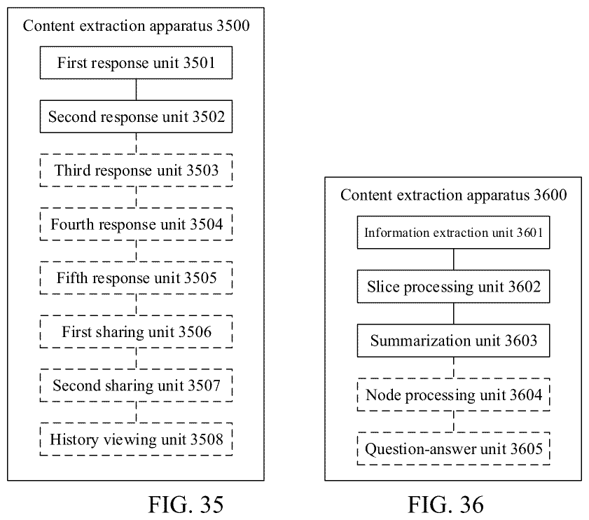

Based on the same inventive concept, some embodiments further provides a content extraction apparatus. FIG. 35 is a schematic structural diagram of a content extraction apparatus 3500. The content extraction apparatus 3500 may include:
a first response unit 3501, configured to present a document selection interface in response to an uploading operation that is triggered based on an information exchange interface, the document selection interface including at least one document; and
a second response unit 3502, configured to: in response to a selection operation on a first document in the at least one document, present the first document in the information exchange interface, and present processing information of the first document in a status area corresponding to the first document, the processing information indicating a current processing stage existing when performing content extraction on the first document and a corresponding processing status; and
after the content extraction on the first document is completed, cancel display of the status area, and present, in the information exchange interface, a document digest obtained by performing content extraction on the first document.

In some embodiments, the status area is in a collapsed form. The second response unit 3502 is further configured to:
switch the status area to an expanded form in response to an expansion operation triggered for the status area; and
present, in the status area in the expanded form, each processing stage existing when performing content extraction on the first document and a respective processing status of each processing stage.

In some embodiments, the second response unit 3502 is further configured to:
present, in the status area, countdown information of an estimated completion time corresponding to a key processing stage if the current processing stage of the first document is the key processing stage,
the key processing stage being at least one of the following: a processing stage in which the estimated completion time exceeds a preset time threshold and a preset processing stage.

In some embodiments, the second response unit 3502 is further configured to:
after the presenting, in the status area in the expanded form, each processing stage existing when performing content extraction on the first document and the respective processing status of each processing stage, present, for a target processing stage in a target processing status in each processing stage in response to a selection operation on any target processing stage, a processing result of the any target processing stage.

In some embodiments, the target processing status includes at least one of completion and processing failure; and the processing result includes at least one of a failure cause and a document
adjustment suggestion when a processing status of the any target processing stage is processing failure.

In some embodiments, when there are multiple first documents, the second response unit 3502 is configured to:
separately present, in the information exchange interface, the first documents and document digests respectively corresponding to the first documents, each first document and the document digest corresponding to the first document being a group of session messages; or
separately present the first documents and a summarized document digest in the information exchange interface, the summarized document digest being a group of session messages obtained by performing summarization processing on multiple document digests after the document digests respectively corresponding to the first documents are separately extracted, and the group of session messages including the multiple first documents and the summarized document digest.

In some embodiments, the second response unit 3502 is further configured to:
present summarization prompt information, the summarization prompt information being configured for prompting whether to perform summarization processing on the document digests respectively corresponding to the first documents, and the summarization processing including at least one of the following: determining a common point for the document digests and determining a difference point for the document digests; and
present, in response to the summarization processing triggered for the summarization prompt information, the summarized document digest that is generated based on the document digests respectively corresponding to the first documents and that corresponds to the summarization processing.

In some embodiments, the first response unit 3501 is further configured to:
before the in response to an uploading operation that is triggered based on an information exchange interface, present the information exchange interface in response to a document summarization operation triggered based on a first function control in a function discovery interface, the information exchange interface including a default session message and a document upload control, the default session message being configured for presenting an example of a document summarization function, and the document summarization function indicating that a document digest is generated by performing content extraction on a document.

The first response unit 3501 is configured to:
present the document selection interface in response to an uploading operation triggered based on the document upload control in the information exchange interface.

In some embodiments, the default session message includes at least one example document, and the first response unit 3501 is further configured to:
before the in response to an uploading operation that is triggered based on an information exchange interface, present, in response to a selection operation on any example document in the at least one example document, a document digest corresponding to the any example document.

The second response unit 3502 is further configured to:
update the at least one example document to a non-interactive state in a processing procedure after the first document is uploaded; and update the at least one example document to an interactive state after the content extraction on the first document is completed.

In some embodiments, the document digest is presented in a form of a session message, and the second response unit 3502 is further configured to:
present a re-summarization control for the first document at a first related location of the document digest; and
re-perform content extraction on the first document in response to a trigger operation on the re-summarization control, and after the content extraction is re-completed, present a new document digest at an original session message corresponding to the document digest.

In some embodiments, the second response unit 3502 is further configured to:
present a digest switching control at a second related location of the document digest; and
switch and display, in response to a switching operation that is triggered based on the digest switching control, multiple document digests that correspond to the first document and that are in the original session message.

In some embodiments, the second response unit 3502 is further configured to:
present, at a third related location of the document digest, a feedback control for evaluating summarization quality of the document digest; and
present a corresponding evaluation result in response to an evaluation operation that is triggered based on the feedback control.

In some embodiments, the apparatus further includes:
a third response unit 3503, configured to present stop prompt information and a corresponding re-summarization control in the information exchange interface in response to a processing stop operation on the first document in a processing procedure of the first document; and
re-perform content extraction on the first document in response to a trigger operation for the re-summarization control, and after the content extraction is re-completed, present, in the information exchange interface, a document digest obtained by performing content extraction on the first document.

In some embodiments, the apparatus further includes:
a fourth response unit 3504, configured to: in response to an exit operation on the information exchange interface in a processing procedure of the first document, present exit prompt information, the exit prompt information being configured for prompting an object of currently processing the first document, and query the object whether to confirm exit.

In some embodiments, if the first document fails to be uploaded, the apparatus further includes:
a fifth response unit 3505, configured to present, in the information exchange interface, a re-upload control; and
re-upload the first document in response to a re-uploading operation that is triggered based on the re-upload control.

In some embodiments, the second response unit 3502 is further configured to:
present an input box in the information exchange interface; and
present, in response to a first question that is inputted based on the input box for the document digest, an answer message corresponding to the first question,
the answer message being any one of the following:

a message that is generated based on the first question and content that is related to the first question in the first document, a message that is generated based on a search result related to the first question, and a message for a predetermined expression indicating that no answer is provided.

In some embodiments, the information exchange interface further includes a second question inputted for non-document content, and the second response unit 3502 is configured to:
present, in a first message style, the first question and the answer message corresponding to the first question; and present, in a second message style, the second question and an answer message corresponding to the second question,
the first question being distinguished from the second question based on at least one of the following manners: predetermined character identification, key information identification, and intention identification.

In some embodiments, the second response unit 3502 is further configured to:
present an input box in the information exchange interface; and
present, in response to a modification instruction that is inputted based on the input box for the document digest, a modified document digest corresponding to the modification instruction.

In some embodiments, the apparatus further includes:
a first sharing unit 3506, configured to present at least one second function control corresponding to the document digest of the first document; and
transmit the document digest and the first document to a to-be-shared object in response to a sharing operation triggered based on the at least one second function control.

In some embodiments, the apparatus further includes:
a second sharing unit 3507, configured to present a shared document, a document digest corresponding to the shared document, and a new session entry; and
present a default session message and a document upload control in the information exchange interface in response to a trigger operation for the new session entry, the default session message being configured for presenting an example of a document summarization function, and the document summarization function indicating that a document digest is generated by performing content extraction on a document.

In some embodiments, the apparatus further includes:
a history viewing unit 3508, configured to present, in response to a viewing operation on a historical record of a target object, historical documents that correspond to the target object and whose document digests have been currently generated; and
present, in response to a viewing operation on any historical document in the historical documents, a document digest corresponding to the any historical document.

Based on the same inventive concept, some embodiments further provides another content extraction apparatus. FIG. 36 is a schematic structural diagram of a content extraction apparatus 3600. The content extraction apparatus 3600 may include:
an information extraction unit 3601, configured to extract text information in a first document after receiving a document processing request for the first document, the first document being uploaded by a client in response to a selection operation on the first document in at least one document in a document selection interface, and the document selection interface being presented by the client in response to an uploading operation that is triggered based on an information exchange interface;
a slice processing unit 3602, configured to slice the extracted text information, to obtain at least one text slice; and separately perform digest extraction on the at least one text slice, to obtain a slice digest respectively corresponding to the at least one text slice; and
a summarization unit 3603, configured to summarize the obtained slice digest, to obtain a document digest corresponding to the first document, and feed back the document digest to the client, so that the client presents, in the information exchange interface, the document digest obtained by performing content extraction on the first document.

In some embodiments, the slice processing unit 3602 is configured to:
separately input the at least one text slice into a content extraction model, and extract, for each text slice, a slice digest corresponding to the text slice by using the content extraction model according to a preconfigured first digest instruction, the first digest instruction being configured for determining a word count and a summary format of the slice digest.

The summarization unit 3603 is configured to:
separately input each slice digest to the content extraction model, and summarize the slice digest by using the content extraction model according to a preconfigured second digest instruction, to generate a document digest, the second digest instruction being configured for determining a word count and a summary format of the document digest.

In some embodiments, the apparatus further includes:
a node processing unit 3604, configured to feed back, in real time, processing information of the first document to the client, so that the client presents the processing information in a status area corresponding to the first document, the processing information indicating a current processing stage existing when performing content extraction on the first document and a corresponding processing status; and
feed back, in real time, an estimated completion time corresponding to a key processing stage to the client, so that the client presents, in the status area, countdown information of the estimated completion time corresponding to the key processing stage when the current processing stage of the first document is the key processing stage.

In some embodiments, when there are multiple first documents, the slice processing unit 3602 is further configured to:
summarize respective topics of the first documents.

The summarization unit 3603 is further configured to:
summarize document digests corresponding to the first documents based on the respective topics of the first documents, to obtain a summarized document digest, and feed back the summarized document digest to the client, so that the client presents the summarized document digest in a form of a session message in the information exchange interface.

In some embodiments, the apparatus further includes:
a question-answer unit 3605, configured to obtain a first question inputted by an object for the document digest;
rewrite the first question with reference to a question that is inputted before the first question, and a corresponding answer message, to obtain a modified first question;
extract first feature information corresponding to the modified first question, and obtain second feature information corresponding to each content slice in the first document, each content slice being obtained by dividing the first document based on a preset slice granularity; and
separately match the first feature information with each piece of second feature information, and generate, according to a matching result, an answer message corresponding to the first question.

In some embodiments, the slice processing unit 3602 is configured to perform digest extraction on the at least one text slice in parallel, to obtain a slice digest respectively corresponding to the at least one text slice.

For ease of description, the foregoing parts are divided into modules (or units) based on functions for respective description. Certainly, during implementation of some embodiments, functions of the modules (or units) may be implemented in one or more pieces of software or hardware.

After the content extraction method and apparatus according to exemplary implementations of some embodiments are described, next, an electronic device according to another exemplary implementation of some embodiments is described.

A person skilled in the art can understand that various aspects of some embodiments may be implemented as a system, a method, or a program product. Therefore, aspects of some embodiments may be implemented in the following forms: a completely hardware implementation, a completely software implementation (including firmware, microcode, and the like), or an implementation combining hardware and software aspects, which may be collectively referred to as a “circuit”, a “module”, or a “system” herein.

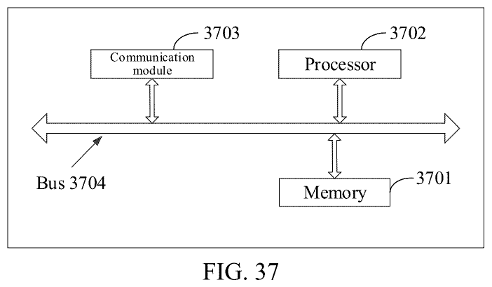

Based on the same inventive concept as the foregoing method embodiment, an electronic device is further provided in some embodiments. In an embodiment, the electronic device may be a server, for example, the server 120 shown in FIG. 1. In this embodiment, as shown in FIG. 37, a structure of the electronic device may include a memory 3701, a communication module 3703, and one or more processors 3702.

The memory 3701 is configured to store a computer program executed by the processor 3702. The memory 3701 may mainly include a program storage area and a data storage area. The program storage area may store an operating system, programs required for running instant messaging functions, and the like. The data storage area may store instant messaging information, operating instruction sets, and the like.

The memory 3701 may be a volatile memory such as a random-access memory (RAM); or may be a non-volatile memory such as a read-only memory, a flash memory, a hard disk drive (HDD), or a solid-state drive (SSD); or may be any other medium capable of carrying or storing a desired computer program in the form of instructions or data structures and capable of being accessed by a computer, but is not limited thereto. The memory 3701 may be a combination of the foregoing memories.

The processor 3702 may include one or more central processing units (CPU), a digital processing unit, or the like. The processor 3702 is configured to invoke the computer program stored in the memory 3701 to implement the foregoing content extraction method.

The communication module 3703 is configured to communicate with a terminal device and other servers.

A specific connection medium between the memory 3701, the communication module 3703, and the processor 3702 is not limited herein. In some embodiments, as shown in FIG. 37, the memory 3701 is connected to the processor 3702 via a bus 3704, and the bus 3704 is indicated by a thick line in FIG. 37. The connection methods between other components are merely illustrative and are not intended to be limiting. The bus 3704 may be classified into an address bus, a data bus, a control bus, and the like. For case of description, the bus in FIG. 37 is described by using only one bold line. However, this does not describe that there is only one bus or one type of bus.

The memory 3701 has a computer storage medium stored therein. The computer storage medium has computer-executable instructions stored therein. The computer-executable instructions are configured for implementing the content extraction method in some embodiments. The processor 3702 is configured to perform the foregoing live content extraction method, as shown in FIG. 30.

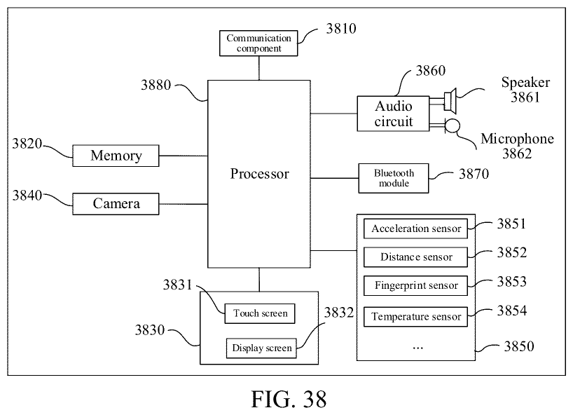

In another embodiment, the electronic device may be another electronic device, such as the terminal device 110 shown in FIG. 1. In this embodiment, as shown in FIG. 38, the structure of the electronic device may include a communication component 3810, a memory 3820, a display unit 3830, a camera 3840, a sensor 3850, an audio circuit 3860, a Bluetooth module 3870, a processor 3880, and other components.

The communication component 3810 is configured to communicate with a server. In some embodiments, the structure of the electronic device may further include a wireless fidelity (WiFi) module. The WiFi module is a short distance wireless transmission technology, and the electronic device may help a user transmit and receive information through the WiFi module.

The memory 3820 may be configured to store a software program and data. The processor 3880 executes various functions of the terminal device 110 and processes data by running the software program or data stored in the memory 3820. The memory 3820 may include a high-speed RAM, and may further include a non-volatile memory, such as at least one magnetic disk storage device, a flash memory device, or another volatile solid-state storage device. The memory 3820 stores an operating system that enables the terminal device 110 to run. In some embodiments, the memory 3820 may store an operating system and various application programs, and may further store a computer program configured for performing the content extraction method provided in some embodiments.

The display unit 3830 may be further configured to display information inputted by a user or information provided for a user, and a graphical user interface (GUI) of various menus of the terminal device 110. In some embodiments, the display unit 3830 may include a display screen 3832 arranged on a front surface of the terminal device 110. The display screen 3832 may be configured in the form of liquid crystal display, light-emitting diode, or the like. The display unit 3830 may be configured to display an information exchange interface, a document selection interface, and the like in some embodiments.

The display unit 3830 may further be configured to receive inputted digital or character information, and generate a signal input related to the user setting and function control of the terminal device 110. In some embodiments, the display unit 3830 may include a touch screen 3831 arranged on the front surface of the terminal device 110, which can collect touch operations of the user on or near the touch screen, such as clicking/tapping a button and dragging a scroll box.

The touch screen 3831 may cover the display screen 3832, or the touch screen 3831 and the display screen 3832 may be integrated to implement input and output functions of the terminal device 110. A component formed by integrating the touch screen and the display screen may be referred to as a touch display screen. In some embodiments, the display unit 3830 may display an application and corresponding operations.

The camera 3840 may be configured to capture a static image, and the user may publish the image captured by the camera 3840 through an application. There may be one or more cameras 3840. An optical image of an object is generated through the lens, and is projected onto the photosensitive element.

The terminal device may further include at least one sensor 3850, such as an acceleration sensor 3851, a distance sensor 3852, a fingerprint sensor 3853, and a temperature sensor 3854. The terminal device may further be configured with other sensors such as a gyroscope, a barometer, a hygrometer, a thermometer, an infrared sensor, an optical sensor, and a motion sensor.

The audio circuit 3860, a speaker 3861, and a microphone 3862 may provide audio interfaces between the user and the terminal device 110. The audio circuit 3860 may convert received audio data into an electrical signal and transmit the electrical signal to the speaker 3861. The speaker 3861 converts the electrical signal into a sound signal and outputs the sound signal. The terminal device 110 may be further configured with a volume button, which is configured to adjust a volume of the sound signal. Furthermore, the microphone 3862 converts a collected sound signal into an electrical signal. After receiving the electrical signal, the audio-frequency circuit 3860 converts the electrical signal into audio data, and then outputs the audio data to, for example, another terminal device 110 through the communication component 3810, or outputs the audio data to the memory 3820 for further processing.

The Bluetooth module 3870 is configured to perform information interaction with another Bluetooth device having a Bluetooth module by using a Bluetooth protocol. For example, the terminal device may establish, through the Bluetooth module 3870, a Bluetooth connection with a wearable electronic device (such as a smartwatch) also equipped with a Bluetooth module, to perform data interaction.

The processor 3880 is a control center of the terminal device and is connected to various parts of the entire terminal using various interfaces and lines. Various functions and data processing of the terminal device are executed by running or executing a software program stored in the memory 3820 and invoking data stored in the memory 3820.

In some possible implementations, the aspects of the content extraction method provided in some embodiments are implemented in the form of a program product, which includes a computer program. When the program product runs an electronic device, the computer program is configured for causing the electronic device to perform the operations of the content extraction method according to the foregoing exemplary implementations of some embodiments. For example, the electronic device may perform the operations shown in FIG. 2 or FIG. 30.

In addition, although the operations of the method in some embodiments are described in a specific order in the accompanying drawings, this does not require or imply that these operations need to be performed in the specific order, or all operations shown need to be performed to achieve the expected result. Additionally, or alternatively, some operations may be omitted, multiple operations may be combined into one operation for execution, and/or one operation may be decomposed into multiple operations for execution.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A content extraction method, performed in a client, the method comprising:
presenting a document selection interface based on an uploading operation in an information exchange interface, the document selection interface comprising at least one document;
based on a selection operation on a first document of the at least one document, presenting, in the information exchange interface, the first document and processing information of the first document in a status area corresponding to the first document, the processing information indicating a current processing stage in a process of performing content extraction on the first document and a corresponding processing status; and
after the content extraction on the first document is completed, removing display of the status area, and presenting, in the information exchange interface, a document digest obtained by performing content extraction on the first document.

2. The content extraction method according to claim 1, further comprising:
switching the status area from a collapsed form to an expanded form based on an expansion operation for the status area; and
presenting, in the status area in the expanded form, each processing stage in the process of performing content extraction on the first document and a respective processing status of each processing stage.

3. The content extraction method according to claim 1, further comprising:
presenting, in the status area, countdown information of an estimated completion time corresponding to the current processing stage of the first document based the current processing state being a key processing stage,
the key processing stage being at least one of: a processing stage in which the estimated completion time exceeds a preset time threshold or a preset processing stage.

4. The content extraction method according to claim 2, wherein after the presenting, in the status area in the expanded form, each processing stage in the process of performing content extraction on the first document and the respective processing status of each processing stage, the method further comprises:
presenting, based on a selection operation on a target processing stage having a target processing status, a processing result of the selected target processing stage.

5. The content extraction method according to claim 4, wherein the target processing status comprises at least one of completion and processing failure; and
the processing result comprises at least one of a failure cause and a document adjustment suggestion when a processing status of the any target processing stage is processing failure.

6. The content extraction method according claim 1, wherein when the selection operation includes multiple first documents, the presenting the first document in the information exchange interface and presenting the document digest obtained by performing content extraction on the first document comprises:
separately presenting, in the information exchange interface, the multiple first documents and document digests respectively corresponding to the multiple first documents, each first document of the multiple first documents and each corresponding document digest forming a group of messages.

7. The content extraction method according to claim 6, wherein the separately presenting further comprises:
presenting summarization prompt information configured for prompting whether to perform summarization processing on the document digests respectively corresponding to the multiple first documents, the summarization processing comprising at least one of the following: determining a common point for the document digests and determining a difference point for the document digests; and
presenting, based on the summarization processing being triggered for the summarization prompt information, a summarized document digest that is generated based on the document digests respectively corresponding to the multiple first documents.

8. The content extraction method according to claim 1, wherein before the presenting a document selection interface, the method further comprises:
presenting the information exchange interface based on a document summarization operation being triggered on a first function control in a first interface, the information exchange interface comprising a default message and a document upload control, the default message presenting an example of a document summarization function, and the document summarization function indicating that a document digest is generated by performing content extraction on a document; and
the presenting the document selection interface comprises:
presenting the document selection interface based on the document upload control in the information exchange interface.

9. The content extraction method according to claim 8, wherein the default message comprises at least one example document, and before the presenting the document selection interface, the method further comprises:
presenting, based on a selection operation on the at least one example documents, a document digest corresponding to the at least one example document.

10. The content extraction method according to claim 1, further comprising:
presenting stop prompt information and a corresponding re-summarization control in the information exchange interface based on a processing stop operation being performed on the first document in a process of performing content extraction on the first document; and
re-performing content extraction on the first document based on a trigger operation for the re-summarization control, and after the content extraction is re-completed, presenting, in the information exchange interface, the document digest obtained by performing content extraction on the first document.

11. The content extraction method according to claim 1, wherein the presenting, in the information exchange interface, the document digest comprises:
presenting an input box for the document digest in the information exchange interface; and
presenting, based on a first question being inputted in the input box, an answer message corresponding to the first question,
the answer message corresponding to the first question being any one of the following:
a message that is generated based on the first question and content that is related to the first question in the first document, a message that is generated based on a search result related to the first question, and a message for a predetermined expression indicating that no answer is provided.

12. The content extraction method according to claim 11, wherein based on a second question being inputted in the input box for non-document content, the method further comprises:
presenting, in a first message style, the first question and the answer message corresponding to the first question; and presenting, in a second message style, the second question and an answer message corresponding to the second question,
the first question being distinguished from the second question based on at least one of: predetermined character identification, key information identification, and intention identification.

13. The content extraction method according to claim 1, wherein the presenting, in the information exchange interface, the document comprises:
presenting an input box for the document digest in the information exchange interface; and
presenting, based on a modification instruction being inputted in the input box, a modified document digest corresponding to the modification instruction.

14. The content extraction method according to claim 1, the method further comprising:
presenting at least one second function control corresponding to the document digest of the first document; and
transmitting the document digest and the first document to a to-be-shared user based on a sharing operation being performed on the at least one second function control.

15. The content extraction method according to claim 1, further comprising:
presenting a shared document, a shared document digest corresponding to the shared document, and a new session entry; and
presenting a default message and a document upload control in the information exchange interface based on a trigger operation for the new session entry, the default message being configured for presenting an example of a document summarization function to a user, and the document summarization function indicating that a document digest is generated by performing content extraction on a document.

16. The content extraction method according to claim 1, further comprising:
presenting, based on a viewing operation being performed on a historical record of a target user, historical documents that correspond to the target user and for which document digests have been generated; and
presenting, based on a viewing operation being performed on a historical document in the historical documents, the document digest corresponding to the historical document.

17. The content extraction method according to claim 1, wherein when the selection operation includes multiple first documents, the presenting the first document in the information exchange interface and presenting the document digest obtained by performing content extraction on the first document comprises:
separately presenting the multiple first documents and a summarized document digest in the information exchange interface, the summarized document digest being obtained by performing summarization processing on document digests respectively corresponding to the multiple first documents, the multiple first documents and the summarized document digest forming a group of messages.

18. The content extraction method according to claim 9, further comprising:
updating the at least one example document to a non-interactive state in a process of performing content extraction after the first document is uploaded; and updating the at least one example document to an interactive state after the content extraction on the first document is completed.

19. A content extraction apparatus, comprising:
at least one memory configured to store computer program code; and
at least one processor configured to read the program code and operate as instructed by the program code, the program code comprising:
first response code configured to cause at least one of the at least one processor to present a document selection interface based on an uploading operation in an information exchange interface, the document selection interface comprising at least one document; and
second response code configured to cause at least one the at least one processor to:
based on a selection operation on a first document of the at least one document, present, in the information exchange interface, the first document and processing information of the first document in a status area corresponding to the first document, the processing information indicating a current processing stage in a process of performing content extraction on the first document and a corresponding processing status; and
after the content extraction on the first document is completed, remove display of the status area, and present, in the information exchange interface, a document digest obtained by performing content extraction on the first document.

20. A non-transitory computer-readable storage medium, storing computer code which, when executed by at least one processor, causes the at least one processor to at least:
present a document selection interface based on an uploading operation in an information exchange interface, the document selection interface comprising at least one document;
based on a selection operation on a first document of the at least one document, present, in the information exchange interface, the first document and processing information of the first document in a status area corresponding to the first document, the processing information indicating a current processing stage in a process of performing content extraction on the first document and a corresponding processing status; and
after the content extraction on the first document is completed, remove display of the status area, and present, in the information exchange interface, a document digest obtained by performing content extraction on the first document.
